(19) United States
(12) Patent Application Publication
(10) Pub. No.: US 2024/0119287 A1
(43) Pub. Date: Apr. 11, 2024

(54) METHODS AND APPARATUS TO CONSTRUCT GRAPHS FROM COALESCED FEATURES

(71) Applicant: Intel Corporation, Santa Clara, CA (US)

(72) Inventors: Ravi H. Motwani, Fremont, CA (US); Ke Ding, Saratoga, CA (US); Jian Zhang, Shanghai (CN); Chendi Xue, Austin, TX (US); Poovaiah Manavattira Palangappa, San Jose, CA (US); Rita Brugarolas Brufau, Hillsboro, OR (US); Xinyao Wang, Shanghai (CN); Yu Zhou, Shanghai (CN); Aasavari Dhananjay Kakne, Santa Clara, CA (US)

(21) Appl. No.: 18/545,762

(22) Filed: Dec. 19, 2023

Related U.S. Application Data
(60) Provisional application No. 63/513,565, filed on Jul. 13, 2023.

(51) Int. Cl. G06N 3/08

(52) U.S. Cl. CPC G06N 3/08

(57) ABSTRACT

Systems, apparatus, articles of manufacture, and methods are disclosed that include interface circuitry, machine readable instructions, and programmable circuitry to at least one of instantiate or execute the machine readable instructions to associate first datapoints of a first feature with a first node, associate second datapoints of a second feature with a second node, construct a graph from the first datapoints and the second datapoints, and perform a comparison of a graph accuracy with a baseline accuracy.

### RELATED APPLICATION

This patent claims the benefit of U.S. Provisional Patent Application No. 63/513,565, which was filed on Jul. 13, 2023. U.S. Provisional Patent Application No. 63/513,565 is hereby incorporated herein by reference in its entirety. Priority to U.S. Provisional Patent Application No. 63/513,565 is hereby claimed.

### FIELD OF THE DISCLOSURE

This disclosure relates generally to cloud computing and, more particularly, to constructing graphs from coalesced features.

### BACKGROUND

In recent years, graphs have been used to represent data. In a graph, various nodes may be connected with edges to other nodes. Representing data as a graph allows for predictions to be inferred from graph neural networks. A bipartite graph is defined as a graph whose vertices can be divided into two disjoint and independent sets U and V, that is every edge connects a vertex in U to one in V. However, representing data via graphs such as a bipartite graph can be challenging in view of protecting privacy and/or other personally identifiable information of the data being presented in the graph.

### BRIEF DESCRIPTION OF THE DRAWINGS

FIG. 1 is a block diagram of an example environment in which example impression calculator circuitry operates to generate a bipartite graph from coalesced features of a privacy protected dataset.

FIG. 2 is a block diagram of an example implementation of the impression calculator circuitry of FIG. 1 to generate a bipartite graph from coalesced features of a privacy protected dataset.

FIG. 3 is a flowchart representative of example machine readable instructions and/or example operations that may be executed, instantiated, and/or performed by example programmable circuitry to implement the impression calculator circuitry of FIG. 2 to generate a base graph.

FIG. 4 is a flowchart representative of example machine readable instructions and/or example operations that may be executed, instantiated, and/or performed by example programmable circuitry to implement the impression calculator circuitry of FIG. 2 to classify features into a first role, a second role, or an edge.

FIG. 5A is a flowchart representative of example machine readable instructions and/or example operations that may be executed, instantiated, and/or performed by example programmable circuitry to implement the impression calculator circuitry of FIG. 2 to generate node embeddings.

FIG. 5B is a flowchart representative of example machine readable instructions and/or example operations that may be executed, instantiated, and/or performed by example programmable circuitry to implement the impression calculator circuitry of FIG. 2 to use the generated node embeddings to generate predictions.

FIG. 6 is a flowchart representative of example machine readable instructions and/or example operations that may be executed, instantiated, and/or performed by example programmable circuitry to implement the impression calculator circuitry of FIG. 2 to assign datapoints to various nodes.

FIG. 7 is a visual representation of an example bipartite graph generated by the impression calculator circuitry of FIG. 2.

FIG. 8 is an example privacy protected dataset of coalesced features.

FIG. 9 is an example of an assignment of a first feature to a first node and a plurality of features associated with a second node.

FIG. 10 is an example of an assignment of a second feature to the first node of FIG. 9.

FIG. 11 is an example results table of multiple runs of the graph that is generated in FIGS. 9-10 based on the impression calculator circuitry of FIG. 2.

FIG. 12 is an example legend for a Rent the Runway dataset and a results data table for the Rent the Runway dataset that is generated by the impression calculator circuitry of FIG. 2.

FIG. 13 is an example association of different features when a similarity protocol is used by the impression calculator circuitry of FIG. 2.

FIG. 14 is an example parameter list of the graph of FIG. 13.

FIG. 15 is an example results table for using a bipartite technique and a similarity technique.

FIG. 16 is a block diagram of an example processing platform including programmable circuitry structured to execute, instantiate, and/or perform the example machine readable instructions and/or perform the example operations of FIGS. 3-6 to implement the impression calculator circuitry of FIG. 2.

FIG. 17 is a block diagram of an example implementation of the programmable circuitry of FIG. 16.

FIG. 18 is a block diagram of another example implementation of the programmable circuitry of FIG. 16.

FIG. 19 is a block diagram of an example software distribution platform to distribute software such as the example machine readable instructions of FIG. 16 to other hardware devices (e.g., hardware devices owned and/or operated by third parties from the owner and/or operator of the software distribution platform).

In general, the same reference numbers will be used throughout the drawing(s) and accompanying written description to refer to the same or like parts. The figures are not necessarily to scale.

### DETAILED DESCRIPTION

Privacy protected datasets obscure user identifiable information from data analysts. For example, in a privacy protected dataset (e.g., privacy enabled dataset) that corresponds to purchases between users and various items, a data analyst is unable to classify different features as relating to either the users or the items. The privacy protected dataset does not provide, either separately or in combination, the user features and item features in raw form that can be identified by a third party, e.g., a third party data analyst. Various privacy protection algorithms are used to transform the user features and item features into a bundle which is provided to the data analyst.

For example, the privacy protected dataset may include data that correspond to user identifiable features such as first data that corresponds to a user name, second data that corresponds to a user age, third data that corresponds to a user location, fourth data that corresponds to an item name, fifth data that corresponds to an item price, sixth data that corresponds to the fact that a specific item was purchased by a specific user, and seventh data that corresponds to the fact that a specific item was viewed by a specific user. In the example privacy protected dataset, the data (e.g., first data, second data, third data, fourth data, fifth data, sixth data, and seventh data) is available, but the corresponding labels describing user identifiable features (e.g., user name, user age, user location, item name, item price, purchased, viewed) is not available.

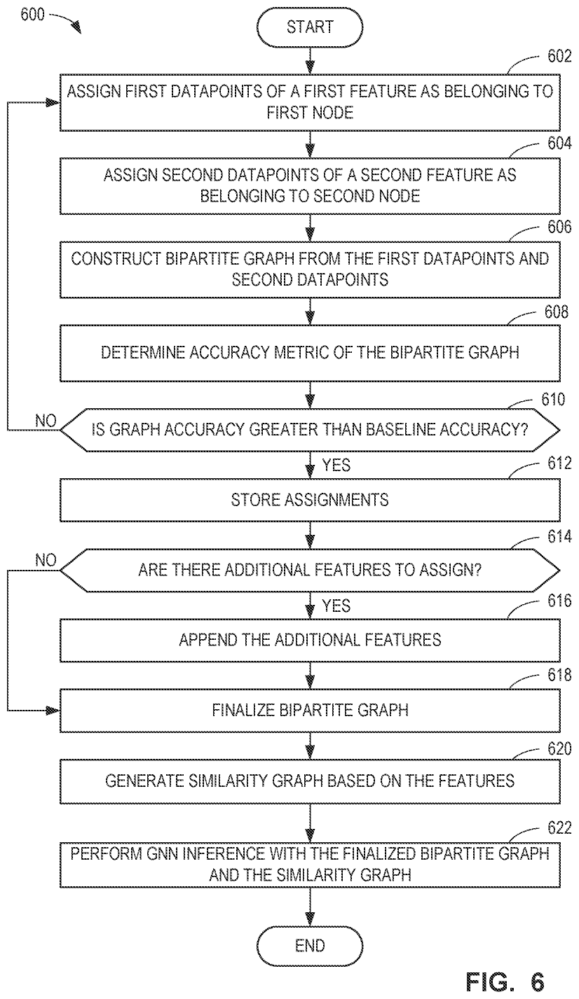

As used herein, a bipartite graph has nodes of a first role that are connected (e.g., has at least one edge) to nodes of a second role. In a bipartite graph, there are no connections (e.g., edges) between the nodes of the first role and the other nodes of the first role. Similarly, there are no connections between the nodes of the second role and the other nodes of the second role. The techniques described herein construct graph neural networks to analyze the data in the privacy protected datasets. Specifically, some techniques described herein build a bipartite graph from the coalesced features of the privacy protected dataset. An example of a bipartite graph that is generated by the techniques disclosed herein is illustrated in FIG. 7.

The techniques disclosed herein associate (e.g., assign, label, link, equate, affiliate, attribute, bin, segregate etc.) some of the coalesced features of a privacy protected dataset as nodes of the first role (e.g., nodes of a first type, first role nodes), some of the coalesced features as nodes of the second role (e.g., nodes of a second type, second role nodes), and some of the coalesced features as edges that connect the nodes of the first role with the nodes of the second role. By associating the features as nodes of the first role (e.g., user features), nodes of the second role (e.g., item features), and edges that connect the nodes of the two different roles (e.g., a user purchased item, a user viewed the item, a user rated the item, a user clicked the item etc.), the disclosed techniques generate a bipartite graph. After generation of the bipartite graph, graph neural network (GNN) algorithms are able to analyze the bipartite graph data and predict various probabilities.

For example, a GNN algorithm may be used to predict links between arbitrary users and items. However, any node classification, link prediction or overall graph related prediction can be performed on the generated bipartite graph. For example, the performance, accuracy, and speed of recommendation systems is increased by the generation of the bipartite graph from the privacy protected dataset of coalesced features.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a graph neural network (GNN) model is used. Using a GNN model enables evaluation of relationships and connections between discrete nodes.

In general, implementing an ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

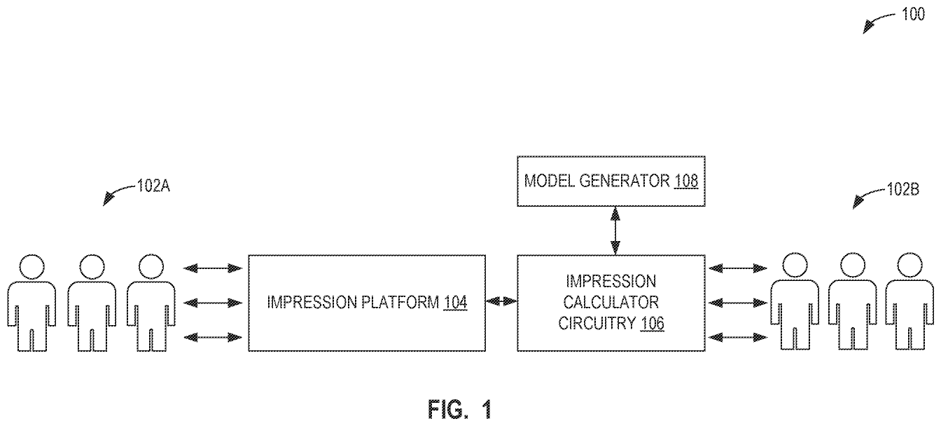

In examples disclosed herein, ML/AI models are trained using stochastic gradient descent. However, any other training algorithm may additionally or alternatively be used. In examples disclosed herein, training is performed at the example impression calculator circuitry 106 (FIG. 1) or the example model generator 108 (FIG. 1). In some examples, the impression calculator circuitry 106 (FIG. 1) uses hyperparameters that control how the learning is performed (e.g., a learning rate, a number of layers to be used in the machine learning model, etc.).

In some examples, the impression calculator circuitry 106 (FIG. 1) inputs training data to complete the training. For example, the training data may be used until a hyperparameter (e.g., learning rate) is used to determine that training is completed. For example, the impression calculator circuitry 106 (FIG. 1) may determine that the example graph neural network is ready for the real data. In examples disclosed herein, the training data originates from the example impression platform 104 (FIG. 1) or is generated from the users 102 (FIG. 1) that are associated with the example impression calculator circuitry 106 (FIG. 1). Because supervised training is used, the training data is labeled.

Once training is complete, the model is deployed for use as an executable construct that processes an input and provides an output based on the network of nodes and connections defined in the model. The model is stored at the example model generator 108 (FIG. 1) or the example impression calculator circuitry 106 (FIG. 1). The model may then be executed by the impression calculator circuitry 106 (FIG. 1).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, the accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

For example, a first dataset analyzed by the techniques disclosed herein is the dataset from the 2023 Recommender Systems Challenge (RecSys 2023) and a second dataset from Rent the Runway. In other examples, other datasets that are privacy preserved may be used. In the RecSys 2023 dataset, there are impressions (e.g., an instance of an advertisement shown to a user), and the requested result is to predict the probability that an application corresponding to the advertisement is installed. In the Rent the Runway dataset, there are user features (e.g., bust size, weight, body type, height, age), item features (e.g., category, size), and edge features (e.g., rented for, rating). The dataset contains 105,508 users, 5,850 items, and 192,544 transactions between the users and the items.

FIG. 1 is a block diagram of an example environment 100 in which example impression calculator circuitry operates to generate a bipartite graph from coalesced features of a privacy protected dataset. The example environment 100 includes an example first plurality of users 102A, an example second plurality of users 102B, an example impression platform 104, example impression calculator circuitry 106, and an example model generator 108.

The example first plurality of users 102A interact with the example impression platform 104. For example, the impression platform 104 may be an online store that sells items and then records the transactions and purchases based on the first plurality of users 102A in a dataset. In some examples, the impression platform 104 applies a privacy protection algorithm on the dataset. In other examples, the impression platform 104 does not apply a privacy protection algorithm on the dataset. In such examples, where the impression platform 104 does not apply a privacy protection algorithm on the dataset, the example impression calculator circuitry 106 applies a privacy protection algorithm on the dataset.

The example impression calculator circuitry 106 is to analyze data from privacy preserved datasets and generate embeddings. The example impression calculator circuitry 106 is in communication with the example impression platform 104 and the example second plurality of users 102B. For example, the impression calculator circuitry 106 receives the dataset from the example impression platform 104. In some examples, the impression calculator circuitry 106 applies a privacy protection algorithm on the dataset if the example impression platform 104 did not previously apply a privacy protection algorithm on the dataset. In some examples, the impression calculator circuitry 106 receives a privacy protected dataset from the impression platform 104. For example, the impression calculator circuitry 106 sources data directly from the second plurality of users 102B. The example impression calculator circuitry 106 applies a privacy protection algorithm on the data that is sourced directly from the second plurality of users 102B. The example impression calculator circuitry 106 is connected to an example model generator 108. In some examples, the impression calculator circuitry 106 generates graph neural network (GNN) algorithms. In other examples, the impression calculator circuitry 106 receives GNNs from the example model generator 108. In other examples, the impression calculator circuitry 106 transmits the bipartite graph for analysis at the example model generator 108.

The example model generator 108 is to train machine learning models and to perform inference with the generated machine learning models. For example, the model generator 108 may receive a base graph from the example impression calculator circuitry 106 and then further train the base graph to generate a fine graph (e.g., a featured enhanced graph). In some examples, the model generator 108 transmits a GNN algorithm for execution and inference at the example impression calculator circuitry 106.

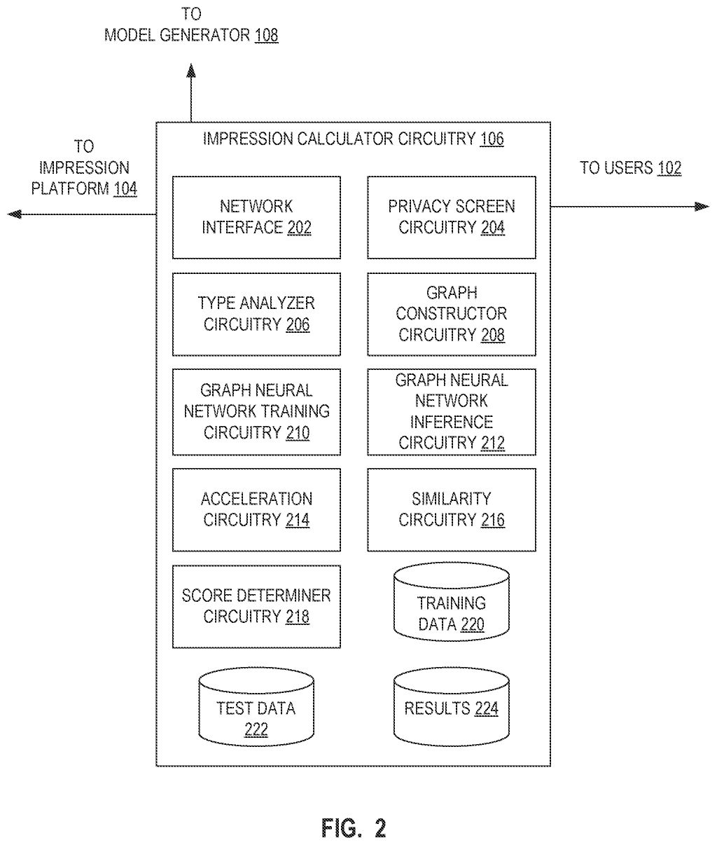

FIG. 2 is a block diagram of an example implementation of the impression calculator circuitry 106 of FIG. 1 to generate a bipartite graph from coalesced features of a privacy protected dataset. The impression calculator circuitry 106 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the impression calculator circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example impression calculator circuitry 106 includes an example network interface 202, example privacy screen circuitry 204, example type analyzer circuitry 206, example graph constructor circuitry 208, example graph neural network training circuitry 210, example graph neural network inference circuitry 212, example acceleration circuitry 214, example similarity circuitry 216, example score determiner circuitry 218, an example training data database 220, an example test data database 222, and an example results data database 224. The example impression calculator circuitry 106 is in communication with the example users 102 (FIG. 1), the example impression platform 104 (FIG. 1), and the example model generator 108 (FIG. 1). The example network interface 202 is to receive either an example privacy protected dataset or a standard dataset from the example impression platform 104. In some examples, the example network interface 202 receives a graph neural network (GNN) algorithm from the example model generator 108.

The example privacy screen circuitry 204 is to apply a privacy protection algorithm on the dataset. For example, the privacy screen circuitry 204 confirms that the dataset received by the network interface circuitry 202 has the personally identifiable information removed (e.g., user information, user data, personal data, etc.). After a determination that the personally identifiable information is not removed, the example privacy screen circuitry 204 applies a privacy protection algorithm to transform the data. The privacy transform is to remove the labels such that the result is a mix of the user features, the item features, and features that connect the user features and the item features. For example, the dataset, once the privacy screen circuitry 204 has operated on the dataset, will include distinct features (e.g., first feature, a second feature, a third feature) and these distinct features will include a number of unique values.

The example type analyzer circuitry 206 is to determine the type of the various features. As used herein, a type of the features refers to either a categorical feature, a binary feature, or a numerical feature. For example, the type analyzer circuitry 206 may analyze the unique values for the features and determine based on the unique values that the twelfth feature (e.g., “f_11”) is a categorical feature, the thirty-sixth feature (e.g., “f_35”) is a binary feature, and the fiftieth feature (e.g., “f_49”) is a numerical feature. For example, a categorical feature (e.g., “f_11”) may correspond to a color of the item (e.g., red, yellow, blue, purple, etc.), a binary feature (e.g., “f_35”) may correspond to an on-sale or full price indication, and a numerical feature (e.g., “f_49”) may correspond to a price of the item (e.g., $30.02, $30.25, $60, etc.). In some examples, the graph constructor circuitry 208 uses the feature type in constructing the bipartite graph. In some examples, the similarity circuitry 216 uses the feature type in constructing a similarity graph by filtering out the categorical features and the binary features and analyzing the numerical features.

The example graph constructor circuitry 208 is to construct the bipartite graph. The example graph constructor circuitry 208 is to select a first feature (e.g., “f_6”) and associate the unique values of the first feature (e.g., 5,167 unique values) as nodes of a first role and select a second feature (e.g., “f_9”) and associate the unique values of the second feature (e.g., 7 unique values) as nodes of a second role. After building the bipartite graph, the graph constructor circuitry 208 uses the score determiner circuitry 218 to determine an accuracy metric (e.g., a logloss value) of the bipartite graph that has the unique values of the first feature as nodes of a first role and has the unique values of the second feature as nodes of a second role. If the accuracy metric improves over a baseline accuracy metric, then the graph constructor circuitry 208 stores the association. The example graph constructor circuitry 208 is to associate (e.g., assign, label, link, equate, affiliate, attribute, bin, segregate etc.) the various different features to either the first node or the second node.

In some examples, the graph constructor circuitry 208 is to select a subset (e.g., sample) of the features for comparison. For example, if there are eighty features, then there are 3,160 different associations (e.g., eighty multiplied by seventy-nine and divided by two) of the different features. In such examples, the graph constructor circuitry 208 may sample ten features and perform forty-five associations. In some examples, the graph constructor circuitry 208 performs the total number of associations based on the full dataset. In some examples, the graph constructor circuitry 208 bins (e.g., attributes) the features as either first features, second features, or labels the feature as an edge feature.

The example graph neural network training circuitry 210 is to train a graph neural network (GNN) algorithm. In some examples, the graph neural network training circuitry 210 is to train the GNN as either a self-supervised GNN technique or a supervised GNN technique. The example embeddings of a coarse graph (e.g., first graph) are used by the example graph neural network training circuitry 210 to fine tune the coarse graph in the training to generate a fine graph (e.g., second graph).

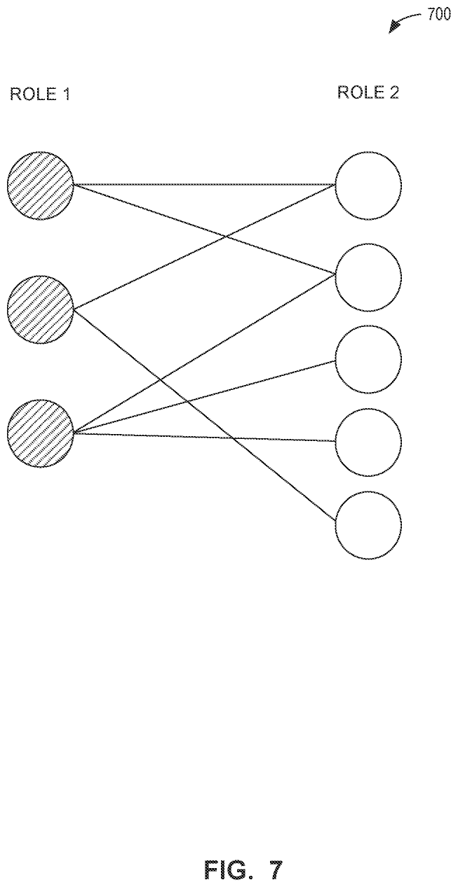

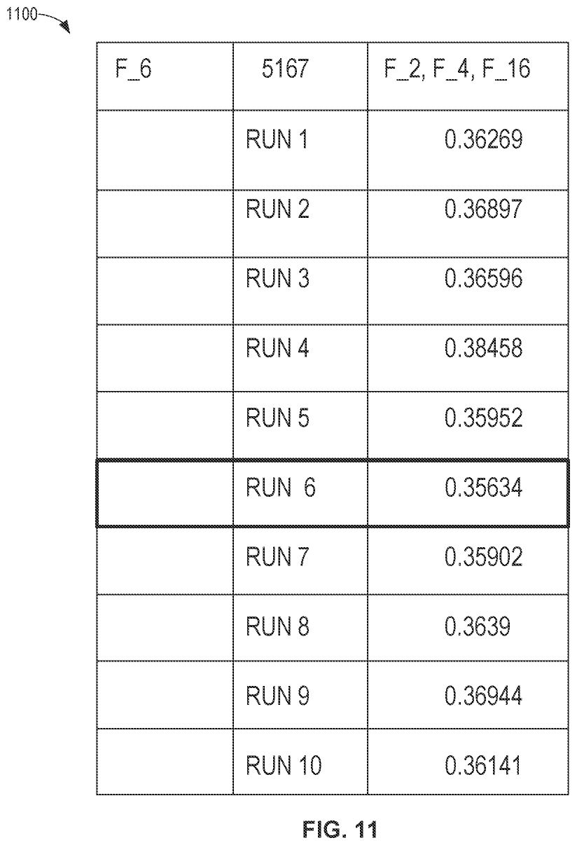

For example, in a self-supervised GNN technique with the F_6 as values of a first node (e.g., 5,167 values) and F_2, F_4, and F_16 as values of a second node (3,309 values) from the table of FIG. 8, the graph neural network training circuitry 210 uses a training dataset of around 3.5 million impressions for training the GNN. In some examples, the unique values of the various features are not the addition of the unique values of the features. For example, an upper limit for the combination of F_2 (e.g., 136 unique values), F_4 (e.g., 633 unique values), and F_16 (e.g., 12 unique values) is the multiplication of the different features (e.g., 136 multiplied by 633 multiplied by 12). The 3.5 million impressions correspond to 3.5 million edges which connect the first node (e.g., users) and the second node (e.g., items). The example graph neural network training circuitry 210 uses the edges which correspond to a binary value of 1 (e.g., “YES”, “is installed”, “is purchased”, etc.) and will ignore the edges which correspond to a binary value of 0 (e.g., “NO”, “is not installed”, “is not purchased”, etc.). The negative sampling for the graph neural network is entries outside of the 3.5 million edges. For example, the graph neural network training circuitry 210 uses a 2-layer MLP as a decoder and the GNN has two layers with a fan-out of forty. The example graph neural network training circuitry 210 generates the embeddings, which are appended and then input as augmented data to the acceleration circuitry 214. For example, the acceleration circuitry 214 may track the “is clicked” probability and append the “is clicked” probability to the “is installed” probability. For example, multiple simulations may be used in the training. FIG. 11 illustrates ten simulations with the first node (e.g., “F_6”) and the second node (e.g., “F_2, F_4, F_16”).

For example, in a supervised GNN technique with the F_6 as values of a first node (e.g., 5,167 values) and F_2, F_4, and F_16 as values of a second node (3,309 values) from the table of FIG. 8, the graph neural network training circuitry 210 uses the remaining 75 features provided in the privacy protected dataset as edge features (e.g., F_0, F_1, F_3, F_5, F_7-F_15, F_17-F_79). In some examples, if a feature only has one entry, the feature is ignored. The example graph neural network training circuitry 210 builds a training graph and a full graph (e.g., inference graph) separately. In some examples, some data from the training graph is held separately for validation. For example, data from a first time period (e.g., Day 0 to Day 65) is used for training, data from a second time period (e.g., Day 66) is used as validation data, and data from a third time period (e.g., Day 67 to Day 100) is used for inference.

For example, the graph neural network training circuitry 210 uses a 2-layer encoder and a 6-layer MLP decoder to generate node embeddings that are further coupled with edge features to generate augmented features. In some examples, using a batch normalization layer over the augmented features before inputting the features into the decoder stabilizes the training process. In some examples, a dropout layer (p=0.5) is used to reduce overfitting. The example graph neural network training circuitry 210 inputs the augmented features to the decoder. In some examples, the graph neural network training circuitry 210 uses binary cross entropy loss to train the encoder-decoder model for 10 epochs with a learning rate of 1e-4 using an optimizer (e.g., AdamW™ optimizer). In some examples, the graph neural network training circuitry 210 sets the probability of selection of test edges during neighborhood sampling to zero to ensure that no messages are passed through the test edges. Therefore, a first test edge that is not equal to a second test edge will not be seen.

After training, the graph neural network training circuitry 210 saves the model (e.g., a trained model) and then loaded separately for inference by the graph neural network inference circuitry 212. In some examples, the model is used by the acceleration circuitry 214 and is further boosted with augmented features. The example acceleration circuitry 214 may generate an accelerated model (e.g., an XGBOOST™ classification algorithm model) which is trained by the example graph neural network training circuitry 210. The accelerated model may be trained on the supervised GNN-boosted data which includes the data from the first time period (e.g., Day 0 to Day 65) and the second time period (e.g., Day 66). In some examples, the accelerated model is deterministic after a random seed is set. The example graph neural network training circuitry 210 tunes the hyperparameters of the accelerated model (e.g., XGBOOST™ classification algorithm model) more easily than the supervised GNN model. In some examples, the accelerated model is trained for 5,000 trees with a learning rate of 5e-3. The example accelerated model is saved and then loaded separately for inference by the graph neural network inference circuitry 212. In some examples, the acceleration circuitry 214 performs inference with the graph neural network inference circuitry 212 to generate a comma separated value (CSV) file with predicted probabilities (e.g., “is installed,” “is viewed,” “is purchased”).

The example graph neural network inference circuitry 212 is to generate embeddings for the nodes of the constructed bipartite graphs. These embeddings (e.g., results) are used by the example graph neural network training circuitry 210 to augment the privacy protected dataset. In some examples, the graph neural network training circuitry 210 and the graph neural network inference circuitry 212 provide the augmented privacy protected dataset to the example acceleration circuitry 214. The example graph neural network inference circuitry 212 performs link prediction based on the nodes of the bipartite graph. For example, in an e-commerce usage scenario, a user-item matrix is an input to the graph neural network inference circuitry 212. In some examples, the user-item matrix is binary based on if the user clicked to view the item. In other examples, the user-item matrix is binary based on if the user purchased the item. In some examples, the user-item matrix is real values (e.g., a user rating for the item).

The example acceleration circuitry 214 is used to accelerate (e.g., increase speed, increase performance, boost, etc.) the neural network inference. In some examples, the acceleration circuitry 214 is implemented by XGBOOST™ classification algorithm. In such examples, the acceleration circuitry 214 is to predict a result probability (e.g., “YES=1” or “NO=0”) based on the augmented privacy protected dataset. For example, a result probability may correspond to a various application being installed or not installed. In some examples, the acceleration circuitry 214 optimizes over pairs of categorical features which maximizes the result probability.

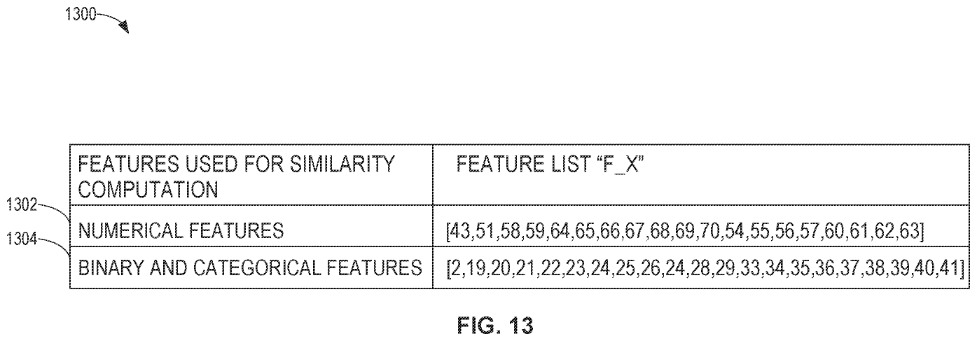

The example similarity circuitry 216 determines a similarity between individual datapoints. For example, the type analyzer circuitry 206 has grouped the dataset 800 of FIG. 8 as categorical features 804 (e.g., “F_2” through “F_32”), binary features 806 (e.g., “F_33” through “F_41”), and numerical features (e.g., “F_42” through “F_79”). Turning briefly to the example of FIG. 13, the similarity circuitry 216 uses a first subset 1302 (FIG. 13) of the features of the dataset 800 (FIG. 8) and a second subset 1304 (FIG. 13) of the features of the dataset 800 (FIG. 8). The example first subset 1302 (FIG. 13) includes some of the numerical features 808 (FIG. 8) identified by the example type analyzer circuitry 206. The example second subset 1304 (FIG. 13) includes some of the binary features 806 (FIG. 8) and some of the categorical features 804 (FIG. 8) identified by the example type analyzer circuitry 206.

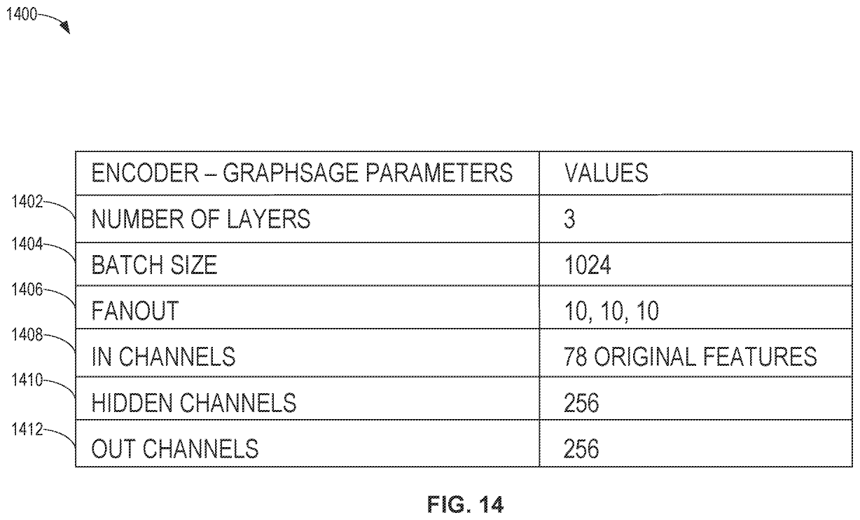

The example similarity circuitry 216 builds a graph from the first subset 1302 (FIG. 13). The example similarity circuitry 216 builds a similarity graph neural network with a plurality of parameters illustrated in FIG. 14. The example first subset 1302 (FIG. 13) includes the numerical features. For example, a first value in a numerical feature (e.g., an age, an income level, a number of items purchased, etc.) has a mathematical relation to a second value in that same numerical feature. For example, a first user may have purchased ten items (e.g., a numerical feature of 10), a second user may have purchased twelve items (e.g., a numerical feature of 12), and a third user may have purchased twenty items (e.g., a numerical feature of 20). For example, the similarity circuitry 216 constructs a graph that connects the first user to the second user and connects the third user to the second user, without connecting the third user to the first user. The example similarity circuitry 216 constructs the similarity graph based on the numerical features.

The example similarity circuitry 216 ignores the categorical features (e.g., geography, eye color, etc.) in assigning similarity. For example, a first number (e.g., 1) may represent a first geography (e.g., the data value one represents California), a second number (e.g., 5) may represent a second geography (e.g., Illinois) and a third number (e.g., 7) may represent a third geography (e.g., New York). However, the similarity circuitry 216 determines that for the categorical feature data, the second number of five is not more similar to the third number of seven. Rather, the example similarity circuitry 216 determines that the categories are distinct, and that only data values that are within one category (e.g., all the users of Illinois) are to be analyzed similarly.

The example score determiner circuitry 218 is to determine the accuracy metrics for the different associations (e.g., assignments, bins, groupings) of the features to either the first node, second node, or the edge nodes that connect the first node and the second node. For example, the score determiner circuitry 218 may use a logloss metric where the lower score is a more accurate score.

The example training data database 220 stores the data that is used by the example graph neural network training circuitry 210. The training data database 220 has data that is separated from the example test data database 222. By separating the data, messages are prevented from being passed. The example test data database 222 includes data that is used for validation and inference. The example results data database 224 includes predictions. For example, the impression calculator circuitry 106 may determine that a first item is likely to be purchased (e.g., a purchasing probability) by a third user if the third user purchased similar items to the first item. In other examples, the impression calculator circuitry 106 may determine that a first item is likely to be purchased by a third user if a first user that is similar to the third user also purchased the first item.

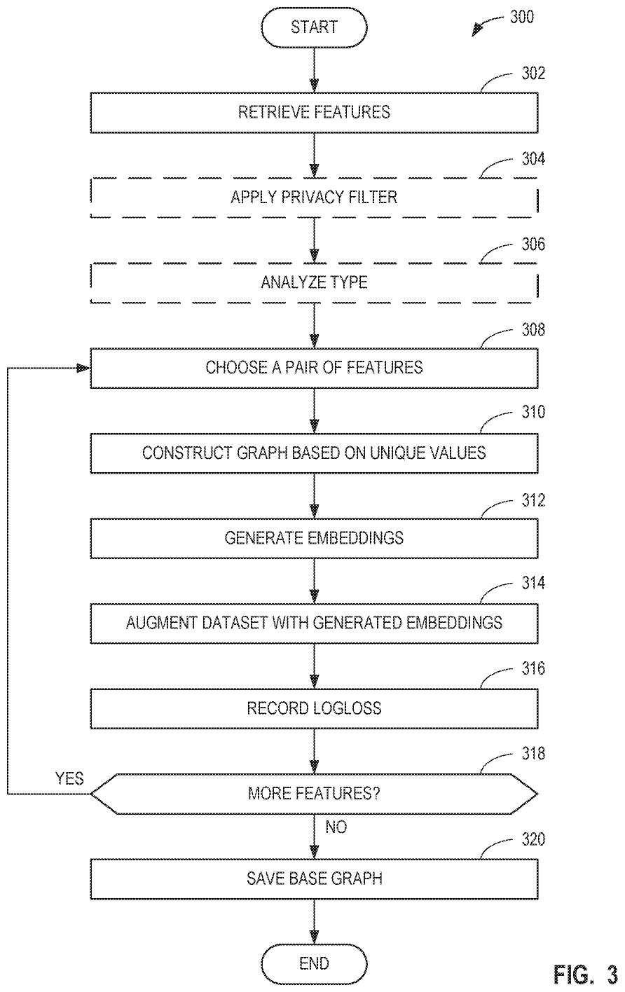

In some examples, the network interface 202 is instantiated by programmable circuitry executing network interface instructions and/or configured to perform operations such as those represented by the flowcharts of FIG. 3.

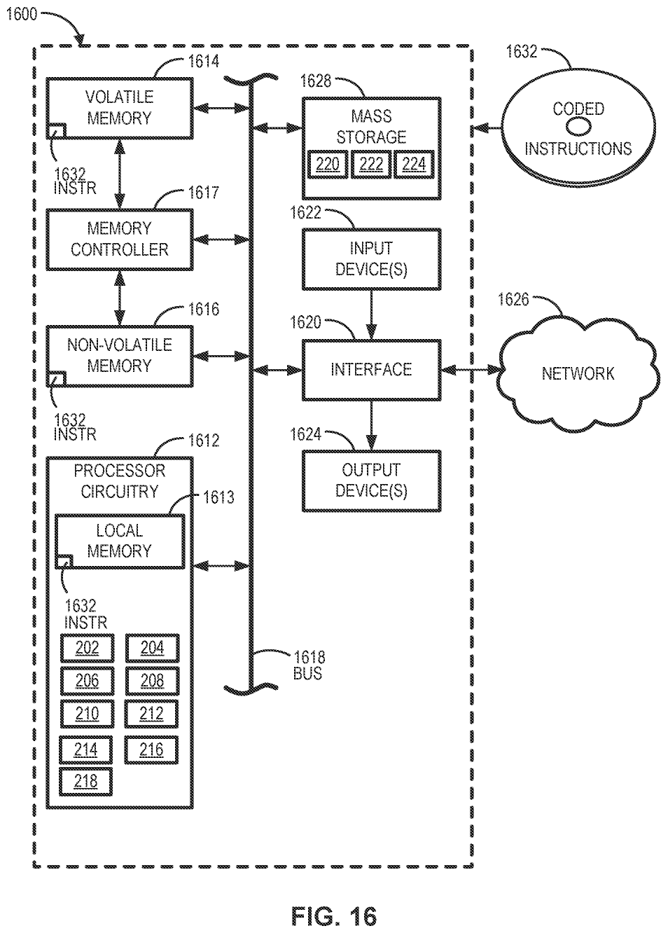

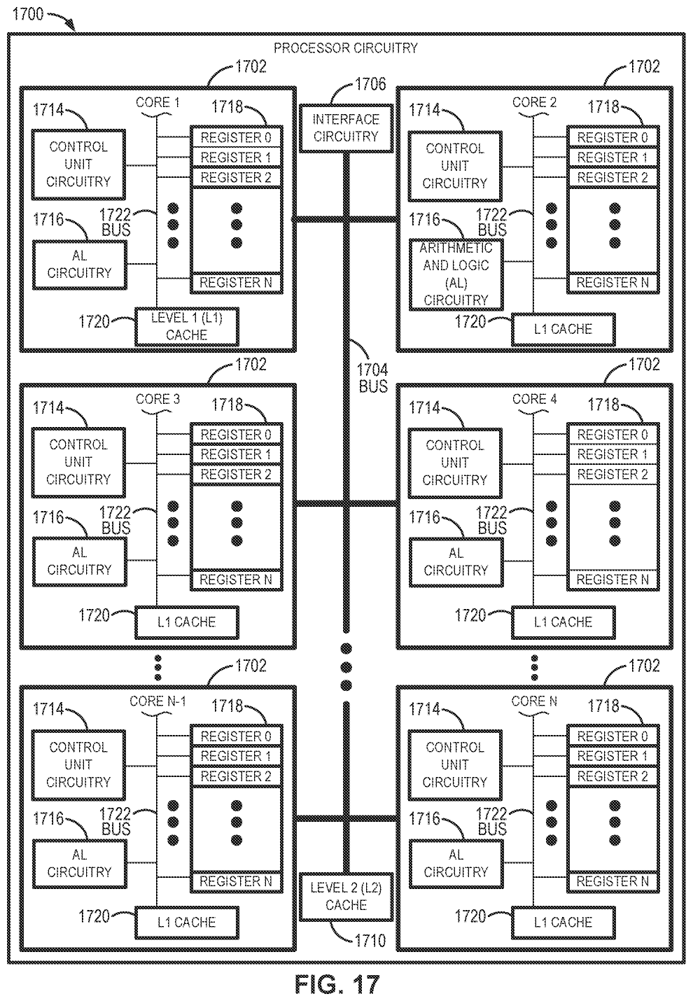

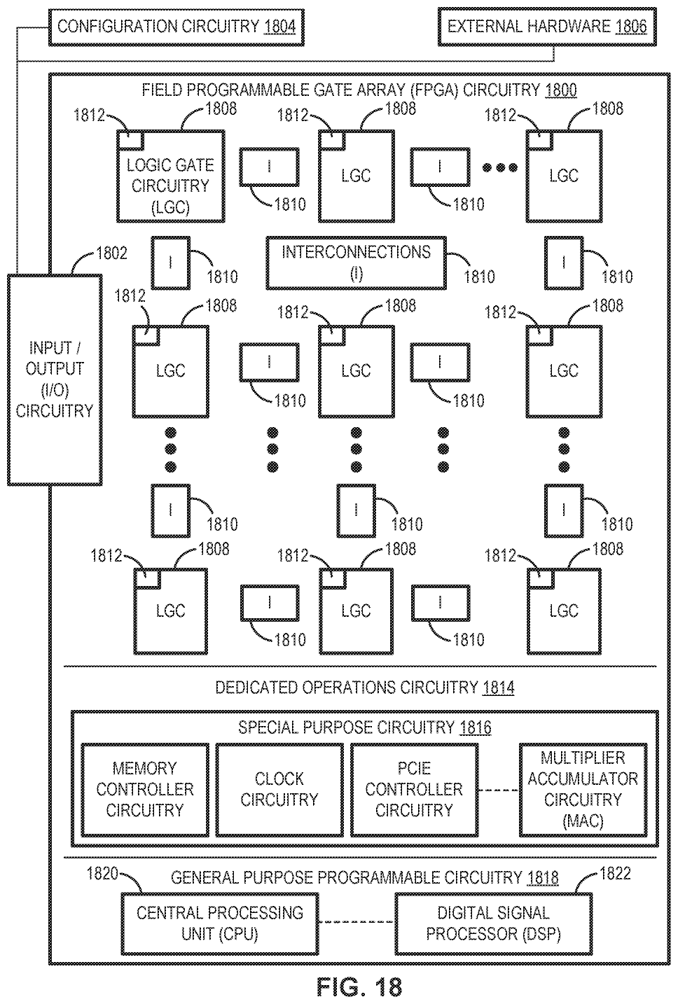

In some examples, the impression calculator circuitry 106 includes means for retrieving privacy protected datasets. For example, the means for retrieving may be implemented by network interface 202. In some examples, the network interface 202 may be instantiated by programmable circuitry such as the example programmable circuitry 1612 of FIG. 16. For instance, the network interface 202 may be instantiated by the example microprocessor 1700 of FIG. 17 executing machine executable instructions such as those implemented by at least block 302 of FIG. 3. In some examples, the network interface 202 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the network interface 202 may be instantiated by any other combination of hardware, software, and/or firmware. For example, the network interface 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the privacy screen circuitry 204 is instantiated by programmable circuitry executing privacy screen instructions and/or configured to perform operations such as those represented by the flowcharts of FIG. 3.

In some examples, the impression calculator circuitry 106 includes means for applying a privacy protection algorithm on datasets. For example, the means for applying a privacy protection algorithm may be implemented by privacy screen circuitry 204. In some examples, the privacy screen circuitry 204 may be instantiated by programmable circuitry such as the example programmable circuitry 1612 of FIG. 16. For instance, the privacy screen circuitry 204 may be instantiated by the example microprocessor 1700 of FIG. 17 executing machine executable instructions such as those implemented by at least block 304 of FIG. 3. In some examples, the privacy screen circuitry 204 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the privacy screen circuitry 204 may be instantiated by any other combination of hardware, software, and/or firmware. For example, the privacy screen circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the type analyzer circuitry 206 is instantiated by programmable circuitry executing type analyzer instructions and/or configured to perform operations such as those represented by the flowcharts of FIG. 3.

In some examples, the impression calculator circuitry 106 includes means for determining feature type in privacy protected datasets. For example, the means for determining feature types may be implemented by type analyzer circuitry 206. In some examples, the type analyzer circuitry 206 may be instantiated by programmable circuitry such as the example programmable circuitry 1612 of FIG. 16. For instance, the type analyzer circuitry 206 may be instantiated by the example microprocessor 1700 of FIG. 17 executing machine executable instructions such as those implemented by at least block 306 of FIG. 3. In some examples, the type analyzer circuitry 206 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the type analyzer circuitry 206 may be instantiated by any other combination of hardware, software, and/or firmware. For example, the type analyzer circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the graph constructor circuitry 208 is instantiated by programmable circuitry executing graph constructor instructions and/or configured to perform operations such as those represented by the flowcharts of FIGS. 3, 4, 5A, 5B, and 6.

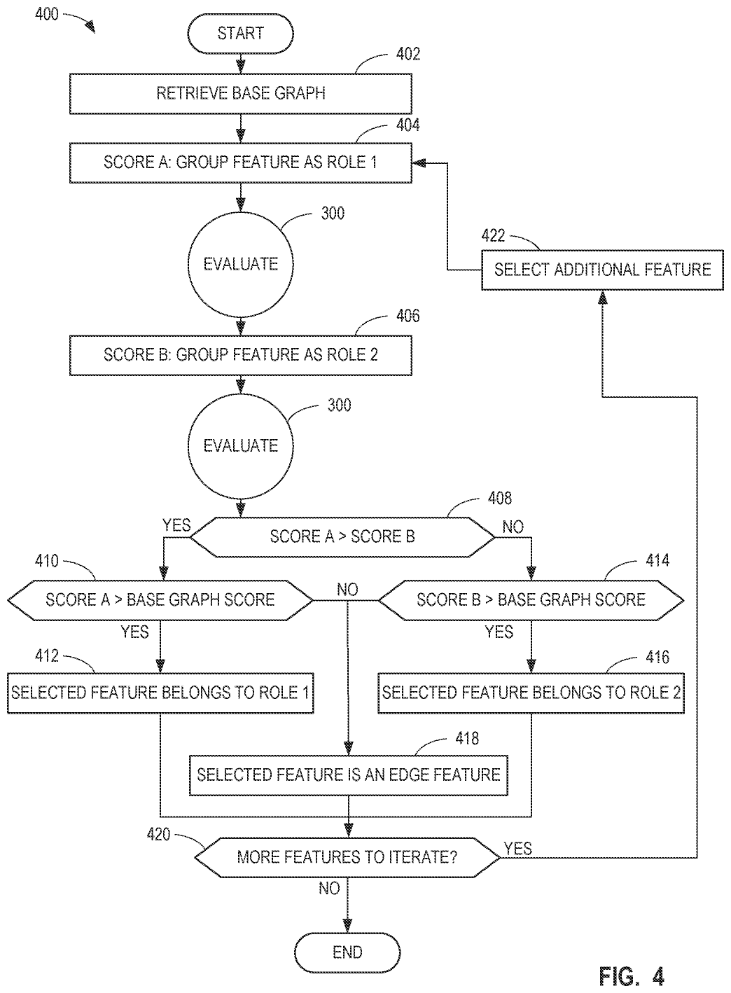

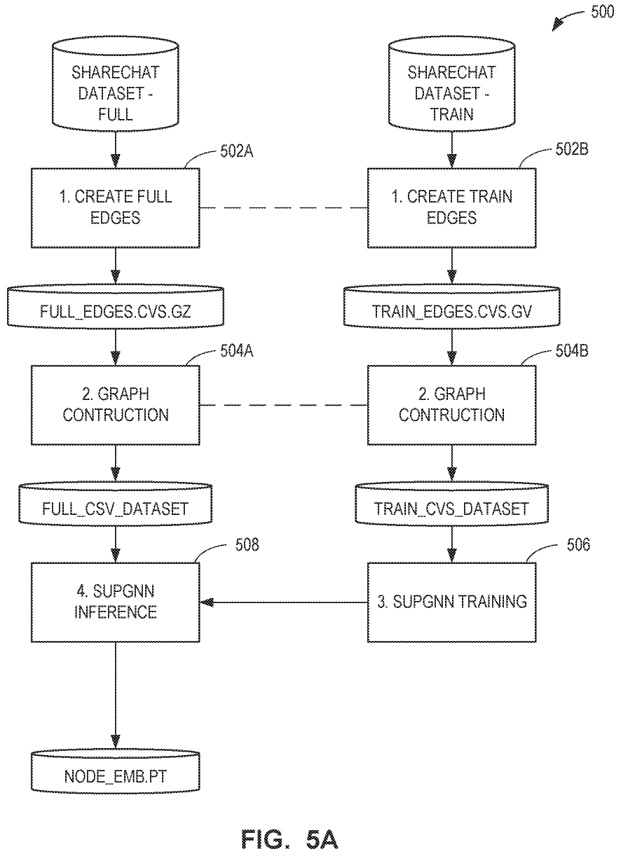

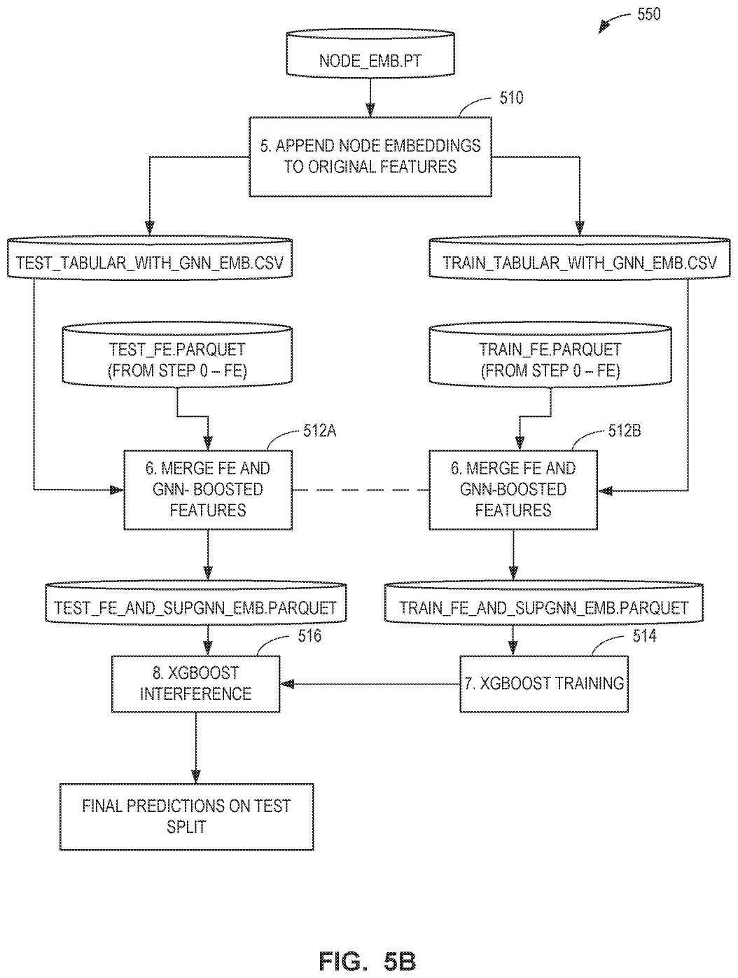

In some examples, the impression calculator circuitry 106 includes means for constructing bipartite graphs from coalesced features of a privacy protected dataset. For example, the means for constructing graphs may be implemented by graph constructor circuitry 208. In some examples, the graph constructor circuitry 208 may be instantiated by programmable circuitry such as the example programmable circuitry 1612 of FIG. 16. For instance, the graph constructor circuitry 208 may be instantiated by the example microprocessor 1700 of FIG. 17 executing machine executable instructions such as those implemented by at least blocks 308, 310, 318, 320 of FIG. 3, blocks 404, 406, 420, 422 of FIG. 4, blocks 502A, 502B, 504A, 504B of FIG. 5A, blocks 510, 512A, 512B of FIG. 5B, and blocks 602, 604, 606, 612, 614, 616, 618 of FIG. 6. In some examples, the graph constructor circuitry 208 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the graph constructor circuitry 208 may be instantiated by any other combination of hardware, software, and/or firmware. For example, the graph constructor circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the graph neural network training circuitry 210 is instantiated by programmable circuitry executing graph neural network training instructions and/or configured to perform operations such as those represented by the flowchart of FIG. 5A.

In some examples, the impression calculator circuitry 106 includes means for training graph neural network algorithms. For example, the means for training graph neural network algorithms may be implemented by graph neural network training circuitry 210. In some examples, the graph neural network training circuitry 210 may be instantiated by programmable circuitry such as the example programmable circuitry 1612 of FIG. 16. For instance, the graph neural network training circuitry 210 may be instantiated by the example microprocessor 1700 of FIG. 17 executing machine executable instructions such as those implemented by at least block 506 of FIG. 5A. In some examples, the graph neural network training circuitry 210 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the graph neural network training circuitry 210 may be instantiated by any other combination of hardware, software, and/or firmware. For example, the graph neural network training circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the graph neural network inference circuitry 212 is instantiated by programmable circuitry executing graph neural network inference instructions and/or configured to perform operations such as those represented by the flowcharts of FIGS. 3, 5A, 5B, 6.

In some examples, the impression calculator circuitry 106 includes means for executing graph neural network algorithms to perform inference. For example, the means for executing graph neural network algorithms may be implemented by graph neural network inference circuitry 212. In some examples, the graph neural network inference circuitry 212 may be instantiated by programmable circuitry such as the example programmable circuitry 1612 of FIG. 16. For instance, the graph neural network inference circuitry 212 may be instantiated by the example microprocessor 1700 of FIG. 17 executing machine executable instructions such as those implemented by at least block 312 of FIG. 3, block 508 of FIG. 5A, block 516 of FIG. 5B, and block 622 of FIG. 6. In some examples, the graph neural network inference circuitry 212 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the graph neural network inference circuitry 212 may be instantiated by any other combination of hardware, software, and/or firmware. For example, the graph neural network inference circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the acceleration circuitry 214 is instantiated by programmable circuitry executing acceleration instructions and/or configured to perform operations such as those represented by the flowcharts of FIGS. 3 and 5B.

In some examples, the impression calculator circuitry 106 includes means for accelerating the prediction of the graph neural network algorithms. For example, the means for accelerating may be implemented by acceleration circuitry 214. In some examples, the acceleration circuitry 214 may be instantiated by programmable circuitry such as the example programmable circuitry 1612 of FIG. 16. For instance, the acceleration circuitry 214 may be instantiated by the example microprocessor 1700 of FIG. 17 executing machine executable instructions such as those implemented by at least block 314 of FIG. 3 and blocks 514, 516 of FIG. 5B. In some examples, the acceleration circuitry 214 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the acceleration circuitry 214 may be instantiated by any other combination of hardware, software, and/or firmware. For example, the acceleration circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the similarity circuitry 216 is instantiated by programmable circuitry executing similarity instructions and/or configured to perform operations such as those represented by the flowchart of FIG. 6.

In some examples, the impression calculator circuitry 106 includes means for generating a similarity graph from the coalesced features of the privacy protected dataset. For example, the means for generating a similarity graph may be implemented by similarity circuitry 216. In some examples, the similarity circuitry 216 may be instantiated by programmable circuitry such as the example programmable circuitry 1612 of FIG. 16. For instance, the similarity circuitry 216 may be instantiated by the example microprocessor 1700 of FIG. 17 executing machine executable instructions such as those implemented by at least block 620 of FIG. 6. In some examples, the similarity circuitry 216 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the similarity circuitry 216 may be instantiated by any other combination of hardware, software, and/or firmware. For example, the similarity circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the score determiner circuitry 218 is instantiated by programmable circuitry executing score determiner instructions and/or configured to perform operations such as those represented by the flowcharts of FIGS. 3, 4, and 6.

In some examples, the impression calculator circuitry 106 includes means for determining an accuracy score. For example, the means for determining an accuracy score may be implemented by score determiner circuitry 218. In some examples, the score determiner circuitry 218 may be instantiated by programmable circuitry such as the example programmable circuitry 1612 of FIG. 16. For instance, the score determiner circuitry 218 may be instantiated by the example microprocessor 1700 of FIG. 17 executing machine executable instructions such as those implemented by at least block 316 of FIG. 3, blocks 408, 410, 414 of FIG. 4, and blocks 608, 610 of FIG. 6. In some examples, the score determiner circuitry 218 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the score determiner circuitry 218 may be instantiated by any other combination of hardware, software, and/or firmware. For example, the score determiner circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the impression calculator circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 202, example privacy screen circuitry 204, the example type analyzer circuitry 206, the example graph constructor circuitry 208, the example graph neural network training circuitry 210, the example graph neural network inference circuitry 212, the example acceleration circuitry 214, the example similarity circuitry 216, the example score determiner circuitry 218, and/or, more generally, the example impression calculator circuitry 106 of FIG. 2, may be implemented by hardware alone or by hardware in combination with software and/or firmware. Thus, for example, any of the example network interface 202, example privacy screen circuitry 204, the example type analyzer circuitry 206, the example graph constructor circuitry 208, the example graph neural network training circuitry 210, the example graph neural network inference circuitry 212, the example acceleration circuitry 214, the example similarity circuitry 216, the example score determiner circuitry 218, and/or, more generally, the example impression calculator circuitry 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example impression calculator circuitry 106 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the impression calculator circuitry 106 of FIG. 2 and/or representative of example operations which may be performed by programmable circuitry to implement and/or instantiate the impression calculator circuitry 106 of FIG. 2, are shown in FIGS. 3-6. The machine readable instructions may be one or more executable programs or portion(s) of one or more executable programs for execution by programmable circuitry such as the programmable circuitry 1612 shown in the example programmable circuitry platform 1600 discussed below in connection with FIG. 16 and/or may be one or more function(s) or portion(s) of functions to be performed by the example programmable circuitry (e.g., an FPGA) discussed below in connection with FIGS. 17 and/or 18. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example impression calculator circuitry 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations that may be executed, instantiated, and/or performed by example programmable circuitry to implement the impression calculator circuitry 106 of FIG. 2 to generate a base graph. At block 302, the example network interface 202 retrieves features. At optional block 304, the example privacy screen circuitry 204 applies a privacy filter. For example, the privacy screen circuitry 204 may apply a privacy filter by using a privacy protection algorithm that transforms the dataset that removes personally identifiable information from the dataset. At optional block 306, the example type analyzer circuitry 206 analyzes the type of the features of the privacy protected dataset. For example, the type analyzer circuitry 206 may analyze the type by determining if the features are numerical, categorical, or binary features.

At block 308, the example graph constructor circuitry 208 chooses a pair of features. For example, the graph constructor circuitry 208 may choose a pair of features by selecting a first feature (e.g., “f_6”) and selecting a second feature (e.g., “f_2”).

At block 310, the example graph constructor circuitry 208 constructs a bipartite graph. For example, the graph constructor circuitry 208 may construct a bipartite graph by associating the unique values of the first feature as a first node (e.g., first role, user role) and associating the unique values of the second feature as a second node (e.g., second role, item role).

At block 312, the example graph neural network inference circuitry 212 is to generate embeddings. For example, the graph neural network inference circuitry 212 may generate embeddings by performing GNN inference on the constructed bipartite graph that is generated by the example graph constructor circuitry 208. In some examples, the graph neural network training circuitry 210 generates a GNN that is used by the example graph neural network inference circuitry 212.

At block 314, the example acceleration circuitry 214 is to augment the dataset with embeddings. For example, the acceleration circuitry 214 may augment the dataset by using a classification algorithm. In some examples, the acceleration circuitry 214 is implemented by an XGBOOST™ classification system (e.g., extreme gradient boosting). By including the embeddings generated by the example graph neural network inference circuitry 212, the acceleration circuitry 214 determines if certain pairings result in more accurate embeddings and stores these pairings.

At block 316, the example score determiner circuitry 218 records the logloss of the dataset. For example, the score determiner circuitry 218 may record an accuracy metric for the various pairings. In some examples, the logloss is the accuracy metric, where a lower logloss score corresponds to a higher accuracy metric.

At block 318, the example graph constructor circuitry 208 the determines if there are more features to analyze. For example, in response the graph constructor circuitry 208 determining that there are more features to analyze (e.g., “YES”), control advances to block 308. Alternatively, in response to the graph constructor circuitry 208 determining that there are not more features to analyze (e.g., “NO”), control advances to block 320. In some examples, the graph constructor circuitry 208 determines there are more features to analyze by determining if there are more entries in a list of the total number of entries.

At block 320, the example graph constructor circuitry 208 selects the base graph. For example, the graph constructor circuitry 208 may select the base graph by determining which bipartite graph has the minimum logloss (e.g., highest accuracy). As used herein, a base graph (e.g., generated graph, standard graph, first graph, etc.) is a graph that is used in subsequent training (e.g., further training). For example, graph constructor circuitry 208 uses the base graph for finetuning as described in connection with FIG. 4. After block 320, the instructions 300 end.

FIG. 4 is a flowchart representative of example machine readable instructions and/or example operations 400 that may be executed, instantiated, and/or performed by programmable circuitry to classify features into a first role, a second role, or an edge. At block 402, the example graph constructor circuitry 208 retrieves the base graph. For example, the graph constructor circuitry 208 determines which bipartite graph has the minimum logloss (e.g., highest accuracy) from block 320 of FIG. 3.

At block 404, the example graph constructor circuitry 208 groups an example first feature as role 1. After block 404, the impression calculator circuitry 106 evaluates the features as role 1 by executing the instructions 300 of FIG. 3 to generate a first bipartite graph score (e.g., “SCORE A”). Control returns to block 406.

At block 406, the example graph constructor circuitry 208 groups an example second feature as role 2. After block 406, the impression calculator circuitry 106 evaluates the features as role 2 by executing the instructions 300 of FIG. 3 to generate a second bipartite graph score (e.g., “SCORE B”). Control returns to block 408.

At block 408, the example score determiner circuitry 218 compares the first bipartite graph score (e.g., “SCORE A”) with the second bipartite graph score (e.g., “SCORE B”). For example, in response to the score determiner circuitry 218 determining that the first bipartite graph score is greater than the second bipartite graph score (e.g., “YES”), control advances to block 410. Alternatively, in response to the score determiner circuitry 218 determining that the first bipartite graph score is not greater than the second bipartite graph score (e.g., “NO”), control advances to block 414.

At block 410, the example score determiner circuitry 218 compares the first bipartite graph score (e.g., “SCORE A”) with a baseline graph score (e.g., “BASE GRAPH SCORE”). For example, in response to the score determiner circuitry 218 determining that the first bipartite graph score is greater than the baseline graph score (e.g., “YES”), control advances to block 412. Alternatively, in response to the score determiner circuitry 218 determining that the first bipartite graph score is not greater than the baseline graph score (e.g., “NO”), control advances to block 418.

At block 414, the example score determiner circuitry 218 compares the second bipartite graph score (e.g., “SCORE B”) with a baseline graph score (e.g., “BASE GRAPH SCORE”). For example, in response to the score determiner circuitry 218 determining that the second bipartite graph score is greater than the baseline graph score (e.g., “YES”), control advances to block 416. Alternatively, in response to the score determiner circuitry 218 determining that the second bipartite graph score is not greater than the baseline graph score (e.g., “NO”), control advances to block 418.

At block 412, the example graph constructor circuitry 208 determines that the selected feature belongs to the first role. For example, if the first role represents the user features, the graph constructor circuitry 208 determines that the selected feature is a user feature (e.g., user name, user age, user location). After block 412, control advances to block 420.

At block 416, the example graph constructor circuitry 208 determines that the selected feature to the second role. For example, if the second role represents the item features, the graph constructor circuitry 208 determines that the selected feature is an item feature (e.g., item name, item price, item color). After block 416, control advances to block 420.

At block 418, the example graph constructor circuitry 208 determines that the selected feature is an edge feature. For example, the graph constructor circuitry 208 may determine that the selected feature is an edge feature that connects the first feature and the second feature (e.g., “purchased”, “installed”, “viewed”). After block 418, control advances to block 420.

At block 420, the example graph constructor circuitry 208 determines if there are more features to iterate over. For example, in response to the graph constructor circuitry 208 determining that there are more features to iterate (e.g., “YES”), control advances to block 422. Alternatively, in response to the graph constructor circuitry 208 determining that there are not more features to iterate (e.g., “NO”), the instructions 400 end.

At block 422, the graph constructor circuitry 208 selects an additional feature. For example, the graph constructor circuitry 208 selects the additional feature to group as role 1, and the process of FIG. 4 repeats.

FIG. 5A is a flowchart representative of example machine readable instructions and/or example operations that may be executed, instantiated, and/or performed by example programmable circuitry to implement the impression calculator circuitry 106 of FIG. 2 to generate node embeddings. In the example of FIG. 5A, the graph neural network training circuitry 210 generates a supervised graph neural network. FIG. 5A is a first portion 500 of a dataflow that takes the training data and generates node embeddings, where the node embeddings are used in the second portion 550 of dataflow of FIG. 5B to augment the dataset for inference.

At block 502A, the example graph constructor circuitry 208 creates full edges (e.g., “FULL_EDGES.CSV.GZ”) from a full dataset (e.g., “SHARECHAT DATASET FULL”). At block 502B, the example graph constructor circuitry 208 creates training edges (e.g., “TRAIN_EDGES.CSV.GZ”) from a training dataset (e.g., “SHARECHAT DATASET TRAIN”).

At block 504A, the graph constructor circuitry 208 builds the full bipartite graph (e.g., “FULL_CSV_DATASET”) from the full edges. At block 504B, the graph constructor circuitry 208 builds the training bipartite graph (e.g., “TRAIN_CSV_DATASET”) from the training edges.

At block 506, the graph neural network training circuitry 210 performs supplemental graph neural network training on the training bipartite graph to generate a saved best model (e.g., saved graph neural network). In some examples, no messages are passed through the test edges from the training bipartite graph.

At block 508, the example graph neural network inference circuitry 212 performs neural network inference with the saved best model and the full dataset to generate node embeddings (e.g., “NODE_EMB.PT”).

FIG. 5B is a flowchart representative of example machine readable instructions and/or example operations that may be executed, instantiated, and/or performed by example programmable circuitry to implement the impression calculator circuitry 106 of FIG. 2 to use the generated node embeddings to generate predictions. At block 510, the graph constructor circuitry 208 takes the node embeddings and appends the node embeddings to the original features of the training dataset (e.g., “TRAIN_TABULAR_WITH_GNN_EMB.CSV”) and the original features of the full dataset (e.g., “TEST_TABULAR_WITH_GNN_EMB.CSV”).

At block 512A, the example graph constructor circuitry 208 merges the FE (feature enhanced, feature engineered, etc.) features and the GNN-Boosted features for the test data. For example, the graph constructor circuitry 208 merges the data from the test database with the appended embeddings and the test FE Parquet™ datafile. At block 512B, the example graph constructor circuitry 208 merges the FE features and the GNN-Boosted features for the training data. For example, the graph constructor circuitry 208 merges the data from the training database with the appended embeddings and the training FE Parquet™ datafile.

At block 514, the example acceleration circuitry 214 (e.g., XGBOOST) trains a classification algorithm (e.g., a classification neural network) with the training database.

At block 516, the example acceleration circuitry 214 (e.g., XGBOOST™ classification algorithm) performs inference (e.g., GNN inference). In some examples, the acceleration circuitry 214 instructs the example graph neural network inference circuitry 212 to perform the GNN inference. After block 516, the example acceleration circuitry 214 saves the final predictions on the test split. For example, the final predictions may represent that a first user has a first probability of purchasing a first item. The flowchart of FIGS. 5A-5B ends.

FIG. 6 is a flowchart representative of example machine readable instructions and/or example operations that may be executed, instantiated, and/or performed by example programmable circuitry to implement the impression calculator circuitry 106 of FIG. 2 to assign datapoints to various nodes. At block 602, the example graph constructor circuitry 208 assigns first datapoints of a first feature as belonging to a first node.

At block 604, the example graph constructor circuitry 208 assigns second datapoints of a second feature as belonging to second node.

At block 606, the example graph constructor circuitry 208 construct bipartite graph from the first datapoints and second datapoints.

At block 608, the example score determiner circuitry 218 determines an accuracy metric of the bipartite graph.

At block 610, the example score determiner circuitry 218 determines the graph accuracy is greater than a baseline accuracy. For example, in response to the score determiner circuitry 218 determining that the graph accuracy is greater than the baseline accuracy (e.g., “YES”), control advances to block 612. Alternatively, in response to the score determiner circuitry 218 determining that the graph accuracy is not greater than the baseline accuracy (e.g., “NO”), control returns to block 602.

At block 612, the example graph constructor circuitry 208 stores the assignments.

At block 614, the example graph constructor circuitry 208 determines if there are any additional features to assign. For example, in response to the graph constructor circuitry 208 determining that there are not additional features to assign (e.g., “NO”), control advances to block 618. Alternatively, in response to the graph constructor circuitry 208 determining that there are additional features to assign (e.g., “YES”), control advances to block 616. In some examples, the graph constructor circuitry 208 may determine if there are more features to assign by determining the privacy dataset.

At block 618, the example graph constructor circuitry 208 finalizes the bipartite graph.

At block 620, the example similarity circuitry 216 generates a similarity graph based on the features. For example, the similarity circuitry 216 generates a similarity graph based on the type of features by determining a numerical similarity for the numerical features and ignoring the categorical and binary features.

At block 622, the example graph neural network inference circuitry 212 performs GNN inference with the finalized bipartite graph (e.g., trained bipartite graph) and the similarity graph (e.g., trained similarity graph). For example, the graph neural network inference circuitry 212 generates predictions that a first user will buy a second item. In some examples, the dataset is augmented based on prior predictions. In other examples, the acceleration circuitry 214 boosts the GNN inference. The instructions 600 end.

FIG. 7 is a visual representation 700 of an example bipartite graph generated by the impression calculator circuitry 106 of FIG. 2. In the example visual representation 700, there are three shaded nodes of a first role (e.g., “ROLE 1”) and there are five unshaded nodes of a second role (e.g., “ROLE 2”). As used herein, a bipartite graph has nodes of a first role that are connected (e.g., has at least one edge) to nodes of a second role. In the bipartite graph, there are no connections (e.g., edges) between the nodes of the first role and the other nodes of the first role. Similarly, there are no connections between the nodes of the second role and the other nodes of the second role. As such, in FIG. 7, there is no connection between the three shaded nodes of the first role. There is no connection between the five unshaded nodes of the second role. The first nodes (e.g., first role nodes, the nodes of the first role, etc.) are connected to the second nodes (e.g., second role nodes, the nodes of the second role, etc.) to form a bipartite graph. The example impression calculator circuitry 106 (FIG. 1) builds the bipartite graph with the example graph constructor circuitry 208 (FIG. 2) and the data from the privacy protected dataset of FIG. 8. In FIG. 7, the data can either be categorical, binary, or numerical data.

FIG. 8 is an example privacy protected dataset of coalesced features. In FIG. 8, only the feature name (F_1, F_2 etc.) and the unique values of that particular feature (e.g., 23, 139, etc.) are shown. For example, the type analyzer circuitry 206 has grouped the dataset 800 of FIG. 8 as categorical features 804 (e.g., “F_2” through “F_32”), binary features 806 (e.g., “F_33” through “F_41”), and numerical features (e.g., “F_42” through “F_79”). The F_0 feature 802 corresponds to the date. The final results are stored as labels 810 (e.g., “is clicked,” and “is installed”).

In the example of FIG. 8, the association of F_6 as a first node and F_15 as a second node by the graph constructor circuitry 208 improved the accuracy metric over the baseline accuracy metric. In some examples, the baseline accuracy metric is the accuracy metric achieved when there are no GNN embeddings used by the acceleration circuitry 214. For example, the graph constructor circuitry 208 builds a bipartite graph where the 5,167 unique values of F_6 are represented as the first node and the unique values of the combination of F_2, F_4, F_16 (e.g., 3,309 unique values) are represented as the second node.

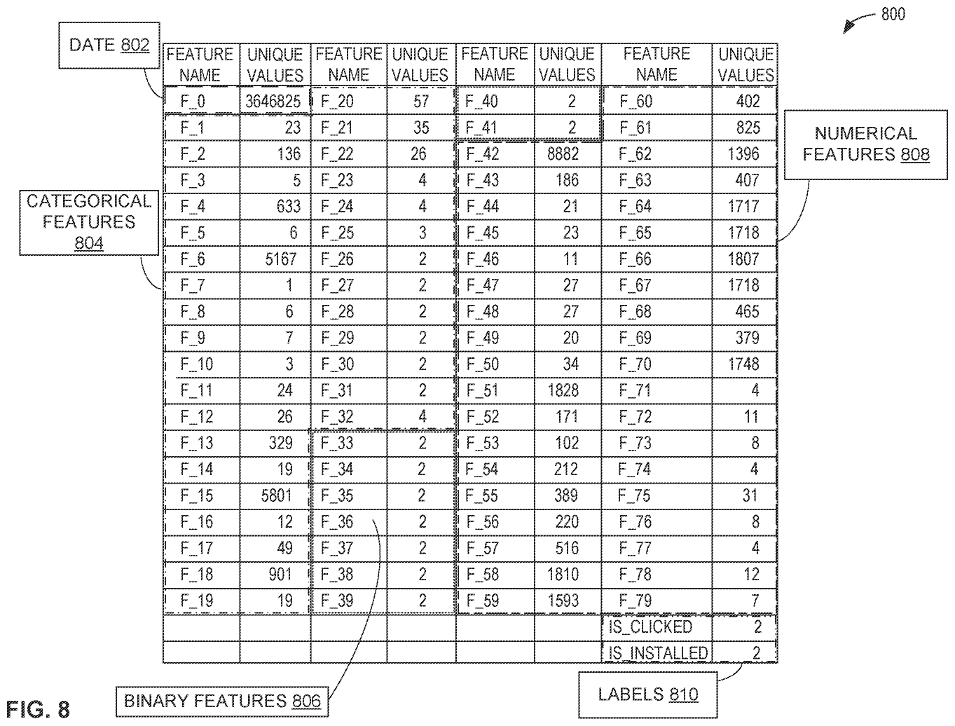

FIG. 9 is an example of an assignment 900 of a first feature to a first node and a plurality of features associated with a second node. In the example of FIG. 9, the example graph constructor circuitry 208 associates the unique values of the sixth feature (e.g., “F_6”) as a first role (e.g., the user) and for a first iteration 902, associates the unique values of the fifteenth feature (e.g., “f_15”) as a second role (e.g., item). For a second iteration 904, the graph constructor circuitry 208 associates the unique values of the eighteenth feature (e.g., “f_18”) as the second role (e.g., item). Similarly, for the third iteration 906, fourth iteration 908, and the fifth iteration 910, the example graph constructor circuitry 208 respectively associates the unique values of the fourth feature (e.g., “f_4”), a thirteenth feature (e.g., “f_13”), and a second feature (e.g., “f_2”) as the second role. In the example of FIG. 9, the example score determiner circuitry 218 determines the accuracy of each of the iterations 902, 904, 906, 908, 910 and determines that the fifth iteration 910 has the greatest accuracy (e.g., the lowest logloss score) with a value of 0.45864 for the label “is clicked” and a value of 0.36302 for the label “is installed.”

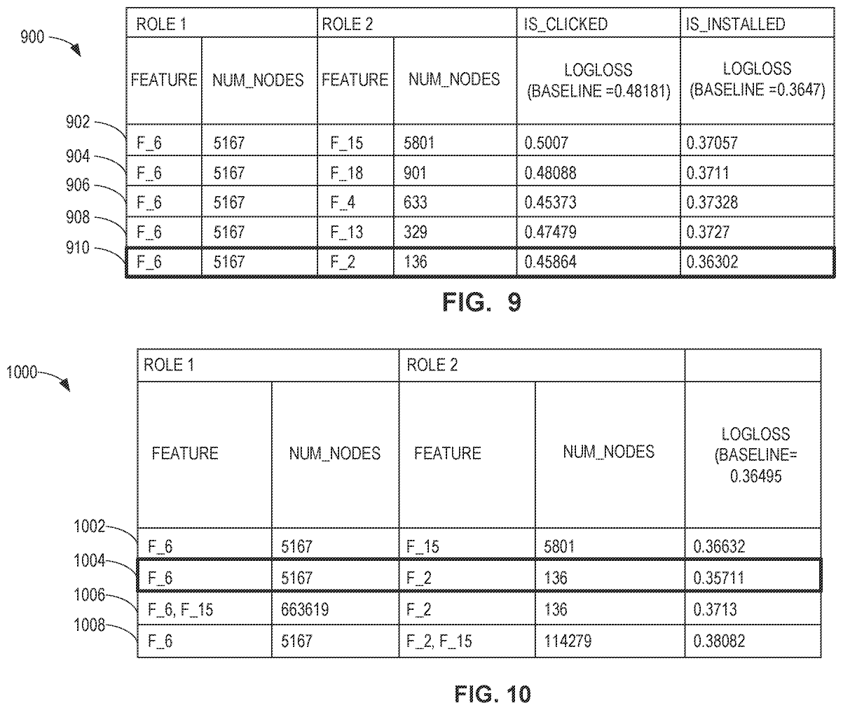

FIG. 10 is an example of an assignment 1000 of a second feature to the first node of FIG. 9. In some examples, the second feature is a subsequent feature, additional feature, extra feature, appended feature. In the example of FIG. 10, the example graph constructor circuitry 208 selects the bipartite graph with the greatest accuracy (e.g., the graph that associates the sixth feature (e.g., “f_6”) as the first role and associates the second feature (e.g., “f_2”) as the second role). The example graph constructor circuitry 208 then is to associate a subsequent feature as either belonging to the first role with the first feature, the second role with the sixth feature, or belonging to neither role.

In the example of FIG. 10, the graph constructor circuitry 208 generates a first iteration 1002 which assigns the sixth feature (e.g., “f_6”) as the first role and assigns the fifteenth feature (e.g., “f_15”) as the second role. The graph constructor circuitry 208 generates a third iteration 1006 which assigns the sixth feature (e.g., “f_6”) and the fifteenth feature (e.g., “f_15”) as belonging to the first role and assigns the second feature (e.g., “f_2”) as belonging to the second role. The graph constructor circuitry 208 generates a fourth iteration 1008 which assigns the sixth feature (e.g., “f_6”) as belonging to the first role and assigns the fifteenth feature (e.g., “f_15”) and the second feature (e.g., “f_2”) as belonging to the second role. However, the accuracy metric for the first iteration 1002, the third iteration 1006, and the fourth iteration 1008 is not as accurate as the second iteration 1004 which does not associate the fifteenth feature (e.g., “f_15”) to either the first role or the second role. Therefore, the graph constructor circuitry 208 determines that the fifteenth feature (e.g., “f_15”) is an edge feature that does not belong to either of the first node or the second node. However, if the fifteenth feature did improve the score, the graph constructor circuitry 208 then is to associate (e.g., append) the datapoints of the subsequent feature (e.g., the fifteenth feature) to either the first node or the second node as based on the first node score and the second node score. The subsequent association (e.g., for example the association of F_4 and F_16 to the second node with F_2) is performed based on the comparison of the logloss scores.

For example, in response to the comparison of the bipartite graph accuracy being less accurate than the baseline accuracy, the example graph constructor circuitry 208 is to subsequently associate the datapoints to generate a different association. For example, the third iteration 1006 which associates the datapoints of the fifteenth feature (e.g., “f_15”) with the datapoints of the sixth feature (e.g., “f_6”) is less accurate than the baseline accuracy. The example graph constructor circuitry 208 performs a subsequent association, in the fourth iteration 1008, by associating the datapoints of the fifteenth feature (e.g., “f_15”) with the datapoints of the second feature (e.g., “f_2”). The association of the fourth iteration 1008 is a different association than the association of the third iteration 1006. In the example of FIG. 10, the fourth iteration 1008 is also less accurate than the baseline accuracy. After the example graph constructor circuitry 208 determines that both the third iteration 1006 and the fourth iteration 1008 are less accurate, the graph constructor circuitry 208 determines that the fifteenth feature (e.g., “f_15”) is an is an edge feature that does not belong to either of the first node or the second node.

FIG. 11 is an example results table 1100 of multiple runs of the graph that is generated in FIGS. 9-10 based on the impression calculator circuitry 106 of FIG. 2. The example graph neural network training circuitry 210 performs ten iterations (e.g., ten runs) of the graph neural network inference to eliminate any randomness from a starting seed value. The example sixth iteration with a value of 0.35634 is chosen with the lowest logloss (e.g., most accurate score).

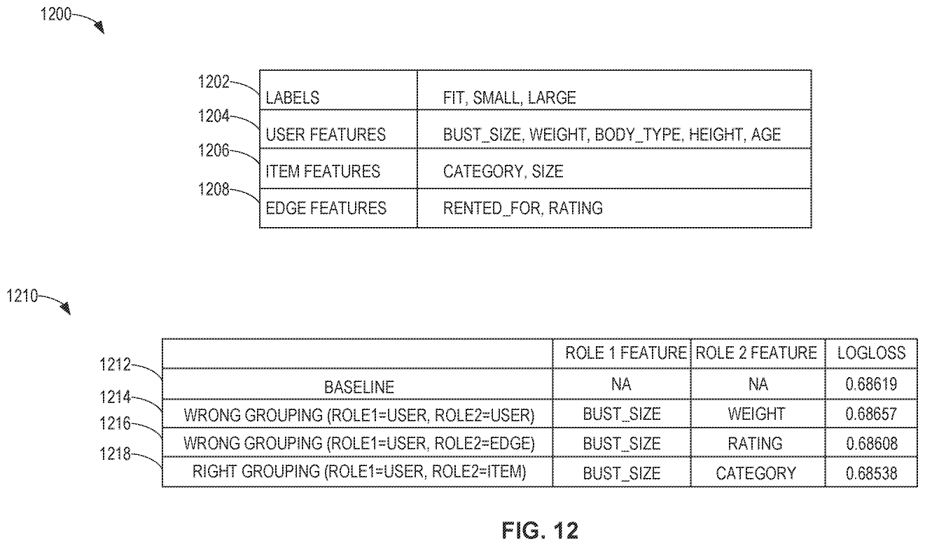

FIG. 12 is an example legend 1200 for a Rent the Runway dataset and a results data table 1210 for the Rent the Runway dataset that is generated by the impression calculator circuitry 106 of FIG. 2. The example legend 1200 includes labels 1202 (e.g., “FIT,” “SMALL,” and “LARGE”), user features 1204 (e.g., “BUST_SIZE,” “WEIGHT,” “BODY_TYPE,” “HEIGHT,” and “AGE”), item features 1206 (e.g., “CATEGORY,” and “SIZE”), and edge features 1208 (e.g., “RENTED_FOR” and “RATING”). The example impression calculator circuitry 106 performs the techniques disclosed herein on the Rent the Runway dataset to generate the results data table 1210.

The example results data table 1210 includes a baseline 1212 (e.g., a logloss score of 0.68619). The example impression calculator circuitry 106 uses the example graph constructor circuitry 208 and the example score determiner circuitry 218 to calculate the score for the first wrong grouping 1214 (e.g., a logloss score of 0.68657), the second wrong grouping 1216 (e.g., a logloss score of 0.68608), and the right grouping 1218 (e.g., a logloss score of 0.68538). For example, the graph constructor circuitry 208 associates a first user feature (e.g., “BUST_SIZE”) and a second user feature (e.g., “WEIGHT”) which is an incorrect pairing as a bipartite graph does not have any connections (e.g., edges) between the first role. The example graph constructor circuitry 208 associates the first user feature (e.g., “BUST_SIZE”) and a first edge feature (e.g., “RATING”) which is an incorrect pairing as a bipartite graph is a connection between two nodes. The example graph constructor circuitry 208 associates the first user feature (e.g., “BUST_SIZE”) and a first item feature (e.g., “CATEGORY”) which is a right grouping because the user represents a first node, and the item represents a second node.

The example score determiner circuitry 218 is to determine that the right grouping 1218 is a more accurate grouping than the first wrong grouping 1214 and the second wrong grouping 1216 because the logloss score of the right grouping 1218 (0.68538) is more accurate than the logloss score of the respective baseline 1212 (0.68619), the example first wrong grouping 1214 (0.68657), and the example second wrong grouping 1216 (0.68608).

FIG. 13 is an example association 1300 of different features when a similarity protocol is used by the impression calculator circuitry 106 of FIG. 2. The example similarity circuitry 216, after the the example type analyzer circuitry 206 distinguishes between the numerical, binary, and categorical features, separates the numerical features from the binary features and the categorical features. The example similarity circuitry 216 then determines how similar a first feature is to a second feature.

In the example of FIG. 13, the similarity circuitry 216 uses a first subset 1302 of the features of the dataset 800 (FIG. 8) and a second subset 1304 of the features of the dataset 800 (FIG. 8). The example first subset 1302 includes some of the numerical features 808 (FIG. 8) identified by the example type analyzer circuitry 206. The example second subset 1304 includes some of the binary features 806 (FIG. 8) and some of the categorical features 804 (FIG. 8) identified by the example type analyzer circuitry 206.

FIG. 14 is an example parameter list of the graph of FIG. 13. In the example of FIG. 14, the graph neural network, built by the example similarity circuitry 216, includes a plurality of parameters 1400. The example first parameter 1402 is the number of layers (e.g., 3 layers). The example second parameter 1404 is the batch size (e.g., 1024 datapoints are evaluated in parallel). The example third parameter 1406 is the fanout (e.g., 10 connections, 10 connections of connections, and 10 connections of connections of connections are sampled). The example fourth parameter 1408 is the in-channels (e.g., 78 original features are input to the graph neural network). The example fifth parameter 1410 is the hidden channels (e.g., 256 hidden layers exist in the graph neural network). The example sixth parameter 1412 is the out-channels (e.g., 256 embeddings are output by the graph neural network).

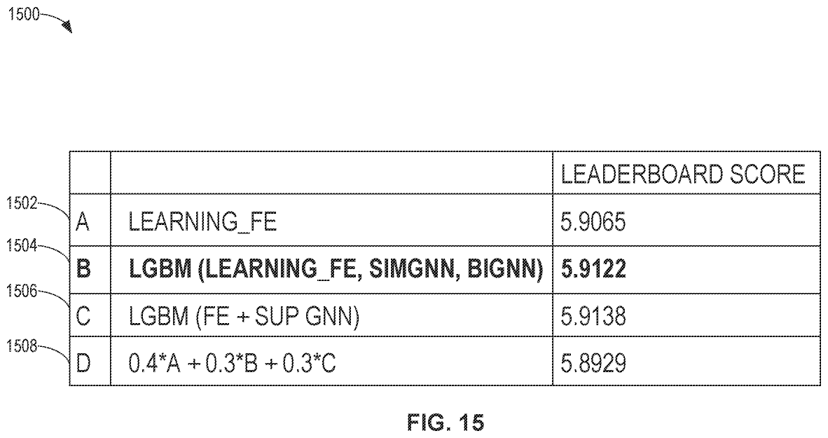

FIG. 15 is an example results table 1500 for using a bipartite technique and a similarity technique. The example results table 1500 illustrates example performance of the various graph neural networks generated by the impression calculator circuitry 106. The example first result 1502 is a Learning_FE dataset (feature engineered, feature enhanced). The example second result 1504 is a combination of the Learning_FE model, a graph neural network trained on the similarity graph generated by the example similarity circuitry 216, and a graph neural network trained on the bipartite graph generated by the graph constructor circuitry 208. The example second result 1504 achieved an improved score compared to the example first result 1502. The example third result 1506 is a Learning_FE model and a supervised graph neural network. The example fourth result 1508 is weighted combination of the example first result 1502, the example second result 1504, and the example third result 1506.

FIG. 16 is a block diagram of an example programmable circuitry platform 1600 structured to execute and/or instantiate the example machine-readable instructions and/or the example operations of FIGS. 3-6 to implement the impression calculator circuitry 106 of FIG. 2. The programmable circuitry platform 1600 can be, for example, a server, a personal computer, a workstation, a self-learning machine (e.g., a neural network), a mobile device (e.g., a cell phone, a smart phone, a tablet such as an iPad™), a set top box, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example network interface 202, the example privacy screen circuitry 204, the example type analyzer circuitry 206, the example graph constructor circuitry 208, the example graph neural network training circuitry 210, the example graph neural network inference circuitry 212, the example acceleration circuitry 214, the example similarity circuitry 216, the example score determiner circuitry 218.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1632, which may be implemented by the machine readable instructions of FIGS. 3-6, may be stored in the mass storage device 1628, in the volatile memory 1614, in the non-volatile memory 1616, and/or on at least one non-transitory computer readable storage medium such as a CD or DVD which may be removable.

FIG. 17 is a block diagram of an example implementation of the programmable circuitry 1612 of FIG. 16. In this example, the programmable circuitry 1612 of FIG. 16 is implemented by a microprocessor 1700. For example, the microprocessor 1700 may be a general-purpose microprocessor (e.g., general-purpose microprocessor circuitry). The microprocessor 1700 executes some or all of the machine-readable instructions of the flowcharts of FIGS. 3-6 to effectively instantiate the circuitry of FIG. 2 as logic circuits to perform operations corresponding to those machine readable instructions. In some such examples, the circuitry of FIG. 2 is instantiated by the hardware circuits of the microprocessor 1700 in combination with the machine-readable instructions. For example, the microprocessor 1700 may be implemented by multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowcharts of FIGS. 3-6.

The cores 1702 may communicate by a first example bus 1704. In some examples, the first bus 1704 may be implemented by a communication bus to effectuate communication associated with one(s) of the cores 1702. For example, the first bus 1704 may be implemented by at least one of an Inter-Integrated Circuit (I2C) bus, a Serial Peripheral Interface (SPI) bus, a PCI bus, or a PCIe bus. Additionally or alternatively, the first bus 1704 may be implemented by any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2 cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the local memory 1720, and a second example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating-point operations. In yet other examples, the AL circuitry 1716 may include first AL circuitry that performs integer-based operations and second AL circuitry that performs floating-point operations. In some examples, the AL circuitry 1716 may be referred to as an Arithmetic Logic Unit (ALU).

The registers 1718 are semiconductor-based structures to store data and/or instructions such as results of one or more of the operations performed by the AL circuitry 1716 of the corresponding core 1702. For example, the registers 1718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure, such as by being distributed throughout the core 1702 to shorten access time. The second bus 1722 may be implemented by at least one of an I2C bus, a SPI bus, a PCI bus, or a PCIe bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages.

The microprocessor 1700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1700, in the same chip package as the microprocessor 1700 and/or in one or more separate packages from the microprocessor 1700.

FIG. 18 is a block diagram of another example implementation of the programmable circuitry 1612 of FIG. 16. In this example, the programmable circuitry 1612 is implemented by FPGA circuitry 1800. For example, the FPGA circuitry 1800 may be implemented by an FPGA. The FPGA circuitry 1800 can be used, for example, to perform operations that could otherwise be performed by the example microprocessor 1700 of FIG. 17 executing corresponding machine readable instructions. However, once configured, the FPGA circuitry 1800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1700 of FIG. 17 described above (which is a general purpose device that may be programmed to execute some or all of the machine readable instructions represented by the flowchart(s) of FIGS. 3-6 but whose interconnections and logic circuitry are fixed once fabricated), the FPGA circuitry 1800 of the example of FIG. 18 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 1800 may be configured and/or structured to effectively instantiate some or all of the operations/functions corresponding to the machine readable instructions of the flowchart(s) of FIGS. 3-6 as dedicated logic circuits to perform the operations/functions corresponding to those software instructions in a dedicated manner analogous to an ASIC. Therefore, the FPGA circuitry 1800 may perform the operations/functions corresponding to the some or all of the machine readable instructions of FIGS. 3-6 faster than the general-purpose microprocessor can execute the same.

In the example of FIG. 18, the FPGA circuitry 1800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

The FPGA circuitry 1800 of FIG. 18, includes example input/output (I/O) circuitry 1802 to obtain and/or output data to/from example configuration circuitry 1804 and/or external hardware 1806. For example, the configuration circuitry 1804 may be implemented by interface circuitry that may obtain a binary file, which may be implemented by a bit stream, data, and/or machine-readable instructions, to configure the FPGA circuitry 1800, or portion(s) thereof. In some such examples, the configuration circuitry 1804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1806 may be implemented by external hardware circuitry. For example, the external hardware 1806 may be implemented by the microprocessor 1700 of FIG. 17.

The FPGA circuitry 1800 also includes an array of example logic gate circuitry 1808, a plurality of example configurable interconnections 1810, and example storage circuitry 1812. The logic gate circuitry 1808 and the configurable interconnections 1810 are configurable to instantiate one or more operations/functions that may correspond to at least some of the machine readable instructions of FIGS. 3-6 and/or other desired operations. The logic gate circuitry 1808 shown in FIG. 18 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations/functions. The logic gate circuitry 1808 may include other electrical structures such as look-up tables (LUTs), registers (e.g., flip-flops or latches), multiplexers, etc.

The configurable interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example dedicated operations circuitry 1814. In this example, the dedicated operations circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the programmable circuitry 1612 of FIG. 16, many other approaches are contemplated. For example, FPGA circuitry may include an on-board CPU, such as one or more of the example CPU 1820 of FIG. 17. Therefore, the programmable circuitry 1612 of FIG. 16 may additionally be implemented by combining at least the example microprocessor 1700 of FIG. 17 and the example FPGA circuitry 1800 of FIG. 18. In some such hybrid examples, one or more cores 1702 of FIG. 17 may execute a first portion of the machine readable instructions represented by the flowchart(s) of FIGS. 3-6 to perform first operation(s)/function(s), the FPGA circuitry 1800 of FIG. 18 may be configured and/or structured to perform second operation(s)/function(s) corresponding to a second portion of the machine readable instructions represented by the flowcharts of FIG. 3-6, and/or an ASIC may be configured and/or structured to perform third operation(s)/function(s) corresponding to a third portion of the machine readable instructions represented by the flowcharts of FIGS. 3-6.

It should be understood that some or all of the circuitry of FIG. 2 may, thus, be instantiated at the same or different times. For example, same and/or different portion(s) of the microprocessor 1700 of FIG. 17 may be programmed to execute portion(s) of machine-readable instructions at the same and/or different times. In some examples, same and/or different portion(s) of the FPGA circuitry 1800 of FIG. 18 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1700 of FIG. 17 may execute machine readable instructions in one or more threads executing concurrently and/or in series. In some examples, the FPGA circuitry 1800 of FIG. 18 may be configured and/or structured to carry out operations/functions concurrently and/or in series. Moreover, in some examples, some or all of the circuitry of FIG. 2 may be implemented within one or more virtual machines and/or containers executing on the microprocessor 1700 of FIG. 17.

In some examples, the programmable circuitry 1612 of FIG. 16 may be in one or more packages. For example, the microprocessor 1700 of FIG. 17 and/or the FPGA circuitry 1800 of FIG. 18 may be in one or more packages. In some examples, an XPU may be implemented by the programmable circuitry 1612 of FIG. 16, which may be in one or more packages. For example, the XPU may include a CPU (e.g., the microprocessor 1700 of FIG. 17, the CPU 1820 of FIG. 18, etc.) in one package, a DSP (e.g., the DSP 1822 of FIG. 18) in another package, a GPU in yet another package, and an FPGA (e.g., the FPGA circuitry 1800 of FIG. 18) in still yet another package.

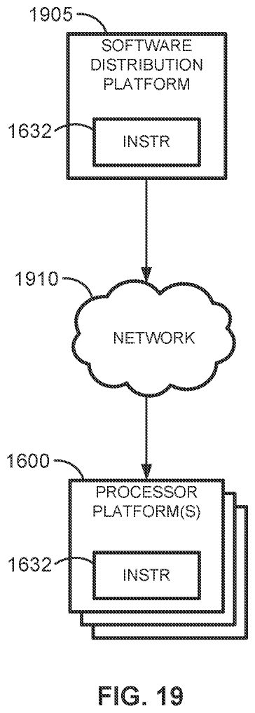

FIG. 19 is a block diagram of an example software distribution platform 1905 to distribute software such as the example machine readable instructions 1632 of FIG. 16 to other hardware devices (e.g., hardware devices owned and/or operated by third parties from the owner and/or operator of the software distribution platform). For example, in FIG. 19, the software distribution platform 1905 is an example software/firmware/instructions distribution platform 1905 (e.g., one or more servers) that distributes software, instructions, and/or firmware (e.g., corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The example software distribution platform 1905 may be implemented by any computer server, data facility, cloud service, etc., capable of storing and transmitting software to other computing devices. The third parties may be customers of the entity owning and/or operating the software distribution platform 1905. For example, the entity that owns and/or operates the software distribution platform 1905 may be a developer, a seller, and/or a licensor of software such as the example machine readable instructions 1632 of FIG. 16. The third parties may be consumers, users, retailers, OEMs, etc., who purchase and/or license the software for use and/or re-sale and/or sub-licensing. In the illustrated example, the software distribution platform 1905 includes one or more servers and one or more storage devices. The storage devices store the machine readable instructions 1632, which may correspond to the example machine readable instructions of FIGS. 3-6, as described above. The one or more servers of the example software distribution platform 1905 are in communication with an example network 1910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 1905. For example, the software, which may correspond to the example machine readable instructions of FIG. 3-6, may be downloaded to the example programmable circuitry platform 1600, which is to execute the machine readable instructions 1632 to implement the impression calculator circuitry 106. In some examples, one or more servers of the software distribution platform 1905 periodically offer, transmit, and/or force updates to the software (e.g., the example machine readable instructions 1632 of FIG. 16) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate bipartite graphs from coalesced features of privacy protected datasets. Disclosed systems, apparatus, articles of manufacture, and methods improve the efficiency of using a computing device by allowing the computer to accurately analyze datasets that improve the logloss score. Prior solutions did not generate an accurate mapping, so the logloss score was high. The disclosed systems, apparatus, articles of manufacture, and methods are able to analyze data unlabeled, coalesced, privacy preserved data, sometimes with 3.5 million edges that connect first nodes to second nodes. In addition, the disclosed systems, apparatus, articles of manufacture, and methods improve the functioning of the computer because the erroneous associations of the data are removed, and graph neural network inference is only performed on the accurate associations of the data. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to construct bipartite graphs from coalesced features are disclosed herein. Further examples and combinations thereof include the following:
Example 1 includes an apparatus including interface circuitry, machine readable instructions, and programmable circuitry to at least one of instantiate or execute the machine readable instructions to associate first datapoints of a first feature with a first node, associate second datapoints of a second feature with a second node, construct a graph from the first datapoints and the second datapoints, and perform a comparison of a graph accuracy with a baseline accuracy.
Example 2 includes the apparatus of example 1, wherein the programmable circuitry is to store the association of the datapoints in response to the comparison of the graph accuracy being more accurate than the baseline accuracy.
Example 3 includes the apparatus of example 1, wherein the programmable circuitry is to subsequently associate the datapoints in response to the comparison of the graph accuracy being less accurate than the baseline accuracy.
Example 4 includes the apparatus of example 1, wherein the programmable circuitry is further to associate third datapoints of a third feature with the first node, associate the third datapoints of the third feature with the second node, and append the third datapoints of the third feature to either the first node or the second node based on a comparison of a first node score and a second node score.
Example 5 includes the apparatus of example 1, wherein the programmable circuitry is to associate third datapoints with an edge feature that connects the first node and the second node in response to i. a graph accuracy of an association of the third datapoints with the first node being less accurate than the baseline accuracy, and ii. a graph accuracy of an association of the third datapoints with the second node being less accurate than the baseline accuracy.
Example 6 includes the apparatus of example 1, wherein the programmable circuitry is further to remove user identifiable information from a dataset that includes the first datapoints and the second datapoints.
Example 7 includes the apparatus of example 6, wherein the programmable circuitry is further to determine a type of the datapoints of the dataset as belonging to either categorical features, binary features, or numerical features.
Example 8 includes the apparatus of example 6, wherein the programmable circuitry is further to determine a similarity of individual datapoints included in the dataset, and generate a similarity graph based on the similarity of the individual datapoints.
Example 9 includes the apparatus of example 8, wherein the programmable circuitry is further to train the similarity graph and a bipartite graph to generate a trained similarity graph and a trained bipartite graph, and perform graph neural network inference based on a combination of the trained similarity graph and the trained bipartite graph.
Example 10 includes the apparatus of example 9, wherein the programmable circuitry is further to augment the datapoints based on results of the graph neural network inference.
Example 11 includes a non-transitory machine readable storage medium including instructions to cause programmable circuitry to at least associate first datapoints of a first feature with a first node, associate second datapoints of a second feature with a second node, construct a graph from the first datapoints and the second datapoints, and perform a comparison of a graph accuracy with a baseline accuracy.
Example 12 includes the non-transitory machine readable storage medium of example 11, wherein the instructions are to cause the programmable circuitry to store the association of the datapoints in response to the comparison of the graph accuracy being more accurate than the baseline accuracy.
Example 13 includes the non-transitory machine readable storage medium of example 11, wherein the instructions are to cause the programmable circuitry to subsequently associate the datapoints in response to the comparison of the graph accuracy being less accurate than the baseline accuracy.
Example 14 includes the non-transitory machine readable storage medium of example 11, wherein the instructions are to cause the programmable circuitry to associate third datapoints of a third feature with the first node, associate the third datapoints of the third feature with the second node, and append the third datapoints of the third feature to either the first node or the second node based on a comparison of a first node score and a second node score.
Example 15 includes a method for generating a graph including associating, by executing an instruction with a processor, first datapoints of a first feature with a first node, associating, by executing an instruction with the processor, second datapoints of a second feature with a second node, constructing, by executing an instruction with the processor, a graph from the first datapoints and the second datapoints, and performing, by executing an instruction with the processor, a comparison of a graph accuracy with a baseline accuracy.
Example 16 includes the method of example 15, further including removing user identifiable information from a dataset that includes the first datapoints and the second datapoints.
Example 17 includes the method of example 15, further including determining a type of the datapoints of a dataset as belonging to either categorical features, binary features, or numerical features.
Example 18 includes the method of example 17, further including determining a similarity of individual datapoints included in the dataset, and generating a similarity graph based on the similarity of the individual datapoints.
Example 19 includes the method of example 18, wherein the graph is a bipartite graph, further including training the bipartite graph and the similarity graph to generate a trained bipartite graph and a trained similarity graph.
Example 20 includes the method of example 19, further including performing graph neural network inference based on a combination of the trained bipartite graph and the trained similarity graph.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
associate first datapoints of a first feature with a first node;
associate second datapoints of a second feature with a second node;
construct a graph from the first datapoints and the second datapoints; and
perform a comparison of a graph accuracy with a baseline accuracy.

2. The apparatus of claim 1, wherein the programmable circuitry is to store the association of the datapoints in response to the comparison of the graph accuracy being more accurate than the baseline accuracy.

3. The apparatus of claim 1, wherein the programmable circuitry is to subsequently associate the datapoints in response to the comparison of the graph accuracy being less accurate than the baseline accuracy.

4. The apparatus of claim 1, wherein the programmable circuitry is further to:
associate third datapoints of a third feature with the first node;
associate the third datapoints of the third feature with the second node; and
append the third datapoints of the third feature to either the first node or the second node based on a comparison of a first node score and a second node score.

5. The apparatus of claim 1, wherein the programmable circuitry is to associate third datapoints with an edge feature that connects the first node and the second node in response to:
i) a graph accuracy of an association of the third datapoints with the first node being less accurate than the baseline accuracy; and
ii) a graph accuracy of an association of the third datapoints with the second node being less accurate than the baseline accuracy.

6. The apparatus of claim 1, wherein the programmable circuitry is further to remove user identifiable information from a dataset that includes the first datapoints and the second datapoints.

7. The apparatus of claim 6, wherein the programmable circuitry is further to determine a type of the datapoints of the dataset as belonging to either categorical features, binary features, or numerical features.

8. The apparatus of claim 6, wherein the programmable circuitry is further to:
determine a similarity of individual datapoints included in the dataset; and
generate a similarity graph based on the similarity of the individual datapoints.

9. The apparatus of claim 8, wherein the programmable circuitry is further to:
train the similarity graph and a bipartite graph to generate a trained similarity graph and a trained bipartite graph; and
perform graph neural network inference based on a combination of the trained similarity graph and the trained bipartite graph.

10. The apparatus of claim 9, wherein the programmable circuitry is further to augment the datapoints based on results of the graph neural network inference.

11. A non-transitory machine readable storage medium comprising instructions to cause programmable circuitry to at least:
associate first datapoints of a first feature with a first node;
associate second datapoints of a second feature with a second node;
construct a graph from the first datapoints and the second datapoints; and
perform a comparison of a graph accuracy with a baseline accuracy.

12. The non-transitory machine readable storage medium of claim 11, wherein the instructions are to cause the programmable circuitry to store the association of the datapoints in response to the comparison of the graph accuracy being more accurate than the baseline accuracy.

13. The non-transitory machine readable storage medium of claim 11, wherein the instructions are to cause the programmable circuitry to subsequently associate the datapoints in response to the comparison of the graph accuracy being less accurate than the baseline accuracy.

14. The non-transitory machine readable storage medium of claim 11, wherein the instructions are to cause the programmable circuitry to:
associate third datapoints of a third feature with the first node;
associate the third datapoints of the third feature with the second node; and
append the third datapoints of the third feature to either the first node or the second node based on a comparison of a first node score and a second node score.

15. A method for generating a graph comprising:
associating, by executing an instruction with a processor, first datapoints of a first feature with a first node;
associating, by executing an instruction with the processor, second datapoints of a second feature with a second node;
constructing, by executing an instruction with the processor, a graph from the first datapoints and the second datapoints; and
performing, by executing an instruction with the processor, a comparison of a graph accuracy with a baseline accuracy.

16. The method of claim 15, further including removing user identifiable information from a dataset that includes the first datapoints and the second datapoints.

17. The method of claim 15, further including determining a type of the datapoints of a dataset as belonging to either categorical features, binary features, or numerical features.

18. The method of claim 17, further including:
determining a similarity of individual datapoints included in the dataset; and
generating a similarity graph based on the similarity of the individual datapoints.

19. The method of claim 18, wherein the graph is a bipartite graph, further including training the bipartite graph and the similarity graph to generate a trained bipartite graph and a trained similarity graph.

20. The method of claim 19, further including performing graph neural network inference based on a combination of the trained bipartite graph and the trained similarity graph.
